(19) United States
(12) Patent Application Publication
(10) Pub. No.: US 2015/0264129 A1
(43) Pub. Date: Sep. 17, 2015

(54) INFORMATION PROCESSING SYSTEM, CLIENT APPARATUS, AND METHOD OF PROCESSING INFORMATION

(71) Applicants: Sachiko TAKEUCHI, Tokyo (JP); Kohta NAGAI, Kanagawa (JP)

(72) Inventors: Sachiko TAKEUCHI, Tokyo (JP); Kohta NAGAI, Kanagawa (JP)

(73) Assignee: RICOH COMPANY, LTD., Tokyo (JP)

(21) Appl. No.: 14/640,102

(22) Filed: Mar. 6, 2015

(30) Foreign Application Priority Data
Mar. 11, 2014 (JP) 2014-047898

(51) Int. Cl. H04L 29/08; G06F 15/167

(52) U.S. Cl. CPC H04L 67/1044; G06F 15/167

(57) ABSTRACT

An information processing system includes at least one information processing apparatus; a receiving unit that receives definition information for defining composition elements of an operation screen displayed on an apparatus connected to the information processing system through a network in order to cause the apparatus and a computer system connected to the information processing system through the network to collaborate through the information processing system from a client apparatus used to edit the definition information; a generation unit that generates display data for displaying a first screen including the operation screen in a mode corresponding to a display unit based on the definition information received by the receiving unit; and a sending unit that sends the display data generated by the generation unit to the client apparatus.

### BACKGROUND OF THE INVENTION

1. Field of the Invention

The present invention relates to an information processing system, a client apparatus, and a method of processing information.

2. Description of the Related Art

A service is provided by a collaboration between an image forming apparatus and a computer system connected to the image forming apparatus through a network such as the Internet. Further, a user can set definition information related to an operation screen displayed on the image forming apparatus for using the above service on a cloud computing service through a terminal such as a personal computer (PC) as disclosed in Japanese Laid-Open Patent Publication No. 2014-32659.

### SUMMARY OF THE INVENTION

It is a general object of at least one embodiment of the present invention to provide a novel and useful information processing system, a client apparatus, and a method of processing information that substantially obviates one or more problems caused by the limitations and disadvantages of the related art.

One aspect of the embodiments of the present invention may be to provide an information processing system including at least one information processing apparatus, the information processing system including a receiving unit that receives definition information for defining composition elements of an operation screen displayed on an apparatus connected to the information processing system through a network in order to cause the apparatus and a computer system connected to the information processing system through the network to collaborate through the information processing system from a client apparatus used to edit the definition information; a generation unit that generates display data for displaying a first screen including the operation screen in a mode corresponding to a display unit based on the definition information received by the receiving unit; and a sending unit that sends the display data generated by the generation unit to the client apparatus.

Additional objects and advantages of the embodiments will be set forth in part in the description which follows, and in part will be clear from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE DRAWINGS

FIG. 1 illustrates an exemplary structure of an information processing system of an embodiment of the present invention.

FIG. 2 illustrates an exemplary hardware structure of a service providing apparatus of the embodiment of the present invention.

FIG. 3 illustrates an exemplary hardware structure of an apparatus of the first embodiment of the present invention.

FIG. 4 illustrates an exemplary functional structure of the service providing apparatus of the embodiment of the present invention.

FIG. 5 illustrates an exemplary functional structure of the apparatus of the embodiment of the present invention.

FIG. 6 illustrates an exemplary process performed along with a preparation operation.

FIG. 7 illustrates an exemplary screen transition displayed on an administrator terminal at a time of the preparation operation.

FIG. 8 illustrates an exemplary structure of a user information memory unit.

FIG. 9 illustrates an exemplary description of apparatus information in an apparatus information file.

FIG. 10 illustrates an exemplary structure of an apparatus information memory unit.

FIG. 11 illustrates an exemplary screen transition for causing account information of an online storage system of a collaboration destination to be registered.

FIG. 12 illustrates an exemplary description of user information in a user information file.

FIG. 13 is a diagram for explaining a conceptual model of a profile.

FIG. 14 is an exemplary display of a profile apparatus setup screen.

FIG. 15 illustrates a structural example of a profile apparatus correspondence memory unit.

FIG. 16 is an exemplary display of a profile edit screen.

FIG. 17 illustrates a structural example of a profile memory unit.

FIG. 18 illustrates an exemplary functional structure of a setup administration unit for editing a profile.

FIG. 19 is a sequence chart for explaining an exemplary process of a switchover process of a display format of a project edit area.

FIG. 20 illustrates an exemplary display of the profile edit screen of a preview type.

FIG. 21 is a flow chart for explaining an exemplary process of a switchover process of the display format of the profile edit screen.

FIG. 22 illustrates an exemplary structure of a layout information memory unit.

FIG. 23 illustrates an exemplary display of a second profile edit screen.

FIG. 24 illustrates a structural example of a usage state memory unit.

FIG. 25 illustrates a second structural example of the profile memory unit.

FIG. 26 is a sequence chart for explaining an exemplary procedure at a time of using a ScanToStorage service.

FIG. 27 illustrates an exemplary display of an operation screen of a scan apparatus application.

### DETAILED DESCRIPTION OF THE PREFERRED EMBODIMENTS

When the above definition information is edited, there is a problem that it is difficult to viscerally imagine how a result of the edition effects (is reflected) an operation screen actually displayed on the image forming apparatus.

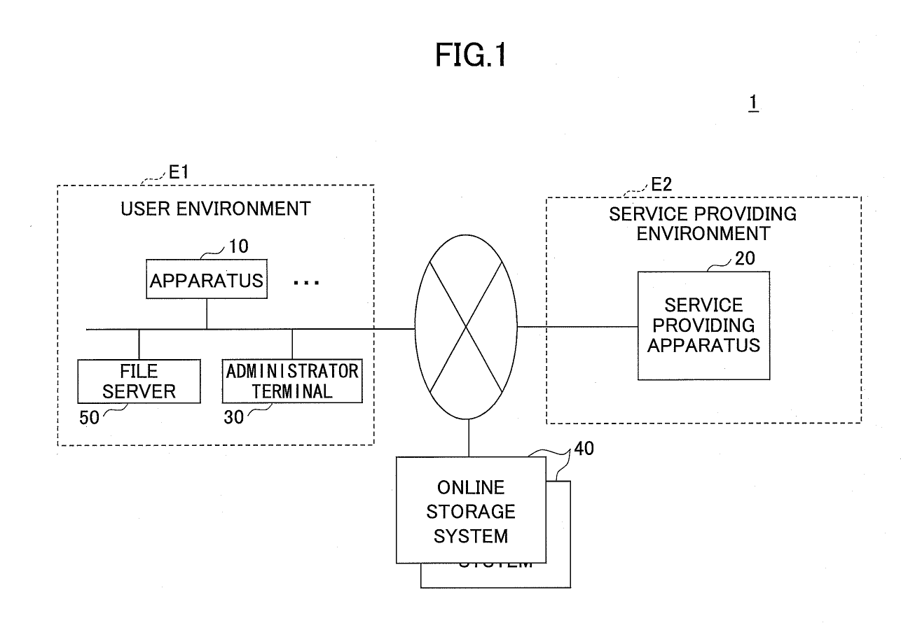

A description is given below, with reference to the FIG. 1 through FIG. 27 of embodiments of the present invention. Where the same reference symbols are attached to the same parts, repeated description of the parts is omitted.

Reference symbols typically designate as follows:
1: information processing system;
10: apparatus;
11: controller;
12: scanner;
13: printer;
14: modem;
15: operation panel;
16: network interface;
17: SD card slot;
20: service providing apparatus;
30: administrator terminal;
40: online storage system;
50: file server;
80: SD card;
111: CPU;
112: RAM;
113: ROM;
114: HDD;
115: NVRAM;
121: apparatus control unit;
122: apparatus authentication unit;
123: communication unit;
124: display control unit;
125: scan apparatus application;
200: drive device;
201: recording medium;
202: auxiliary memory device;
203: memory device;
204: CPU;
205: interface device;
210: server application;
211: scan server application;
220: platform;
221: setup administration unit;
221a: request receiving unit;
221b: profile update unit;
221c: screen generation unit;
221d: response return unit;
222: apparatus communication unit;
223: authentication processing unit;
224: session administration unit;
225: job processing unit;
226: OCR processing unit;
227: upload processing unit;
228: storage collaboration unit;
231: user information memory unit;
232: apparatus information memory unit;
223: apparatus application memory unit;
234: profile memory unit;
235: profile apparatus correspondence memory unit;
236: layout information memory unit;
237: usage history memory unit;
240: platform API; and
B: bus.

In the information processing system 1 illustrated in FIG. 1, a service providing environment E2, a user environment E1, an online storage system 40, and so on are communicable through a wide area network such as the Internet.

The service providing environment E2 is a system environment in an organization which provides a cloud service through a network. Within this embodiment, the cloud service is specifically described. However, the embodiment can be applied to a service provided through the network such as a service provided by an application service provider (ASP), a Web service, and so on.

The service providing environment E2 includes a service providing apparatus 20. The service providing apparatus 20 provides a predetermined service through the network. One of the services provided by the service providing apparatus 20 is a “ScanToStorage service”. Within this embodiment, the ScanToStorage service is described. The ScanToStorage service stores image data scanned by an apparatus 10 in the user environment E1 in a predetermined storage destination. Said differently, the service providing apparatus 20 may be installed in the user environment E1. Said differently, the service providing environment E2 may be included in the user environment E1.

The user environment E1 is a system environment of the apparatus 10 in an organization of the user enterprise or the like. In the user environment E1, at least one apparatus 10 an administrator terminal 30, and a file server are 50 are connected through a network such as a local area network (LAN) or the like.

The apparatus 10 of the embodiment is an image forming apparatus having a scan function. The apparatus 10 may be a multifunction peripheral having print, copy, or facsimile (FAX) communication functions in addition to the scan function.

The administrator terminal 30 is used by an administrator of the apparatus 10 in the user environment E1. An example of the administrator terminal 30 is a personal computer (PC), a personal digital assistance (PDA), a tablet-type terminal, a smart phone, a mobile phone, or the like.

The file server 50 and the online storage system 40 can be a candidate for a storage destination in the ScanToStorage service.

The online storage system 40 is a computer system providing a cloud service called an “online storage” through the network. The online storage is a service of lending a memory area of a storage. In the embodiment, the memory area lent by the online storage is a candidate for a storage destination of image data in the ScanToStorage service provided by the service providing apparatus 20.

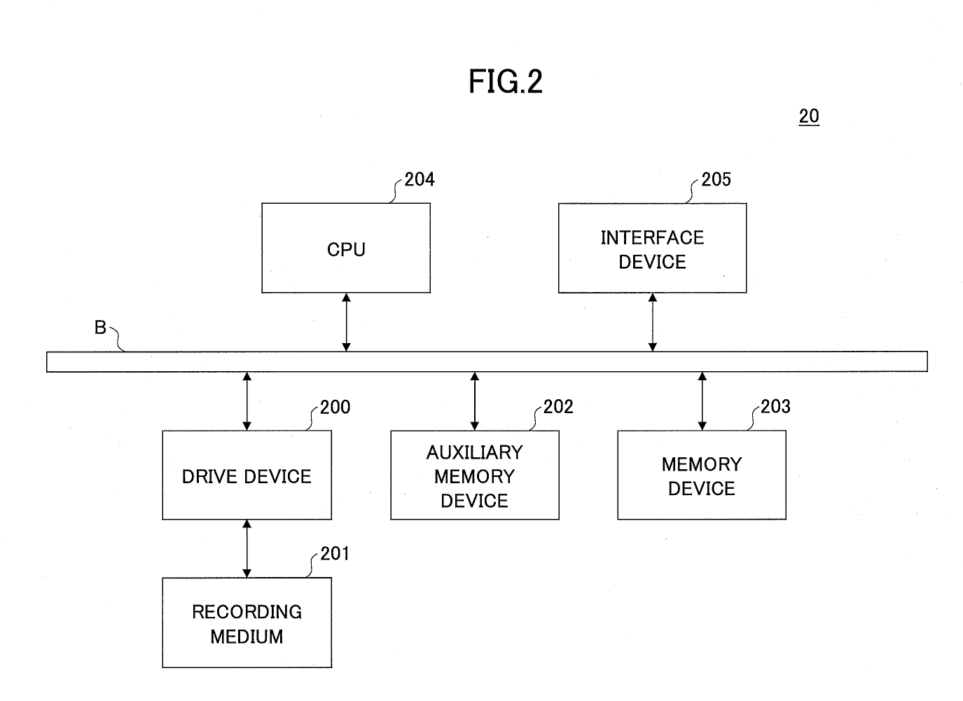

FIG. 2 illustrates an exemplary hardware structure of the service providing apparatus of the embodiment. Referring to FIG. 2, the service providing apparatus 20 includes a drive device 200, an auxiliary memory device 202, a memory device 203, a CPU 204, and an interface device 205, which are mutually connected through a bus B.

A program substantializing processes in the service providing apparatus 20 is supplied by a recording medium 201 such as CD-ROM. When the recording medium 201 having the program recorded on it is set into the drive device 200, the program is installed on the auxiliary memory device 202 through the drive device 200 from the recording medium 201. However, the program may not always be installed from the recording medium 201 and may be downloaded from another computer through the network. The auxiliary memory device 202 stores necessary files, data, and so on in addition to the installed program.

The memory device 203 reads out the program from the auxiliary memory device 202 when the program is instructed to be invoked and stores the read program into the memory device 203. The CPU 204 performs a function related to the service providing apparatus 20 in conformity with the program stored in the memory device 203. The interface device 205 is used as an interface for connecting to the network.

The service providing apparatus 20 may be formed by multiple computers (information processing apparatuses) including hardware illustrated in FIG. 2. Said differently, processes performed by the service providing apparatus 20 described below may be distributed and executed by the multiple computers.

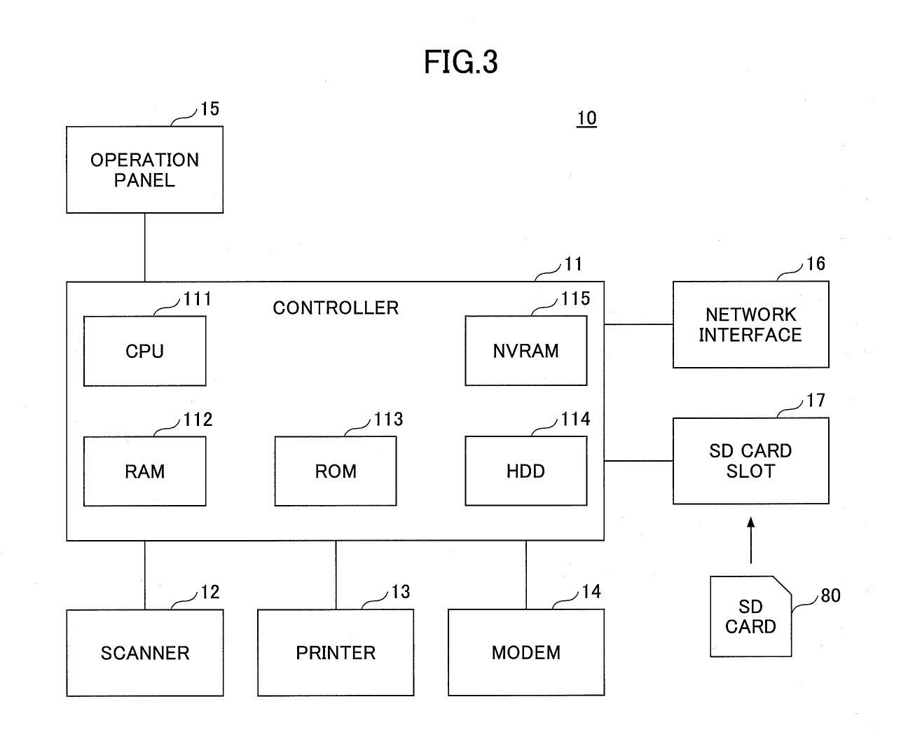

FIG. 3 illustrates an exemplary hardware structure of the apparatus of the embodiment. Referring to FIG. 3, the apparatus 10 includes hardware such as a controller 11, a scanner 12, a printer 13, a modem 14, an operation panel 15, a network interface 16, and an SD card slot 17.

The controller 11 includes a CPU 111, a RAM 112, a ROM 113, an HDD 114, an NVRAM 115, and so on. Various programs and data used by the programs are stored in the ROM 113. The RAM 112 is used as a memory area for loading a program, a work area for the loaded program, or the like. The CPU 111 substantializes various functions by processing the program loaded into the RAM 112. The HDD 114 stores programs, various data used by the programs, or the like. The NVRAM 115 stores various setup information or the like.

The scanner 12 is hardware (an image reading unit) for reading image data from an original (an original manuscript). The printer 13 is hardware (a printing unit) for printing print data on a print paper. The modem 14 is hardware for connecting the apparatus 10 to a telecommunication line and is used for sending and receiving the image data with fax communications. The operation panel 15 is hardware provided with an input unit for receiving an input from the user such as a button, a display unit such as a liquid crystal panel, or the like. The network interface 16 is hardware for connecting the apparatus 10 to a wired or wireless network such as LAN. The SD card slot 17 is used to read a program stored in an SD card 80. Said differently, not only the programs stored in the ROM 113 but also the programs stored in the SD card 80 may be loaded into the RAM 112 and executed by the apparatus 10. The SD card 80 may be replaced by another recording medium such as a CD-ROM and a universal serial bus (USB) memory. The kind of the recording medium such as the SD card 80 is not specifically limited to a predetermined kind. In this case, the SD card slot 17 may be replaced by hardware depending on kinds of the recording medium.

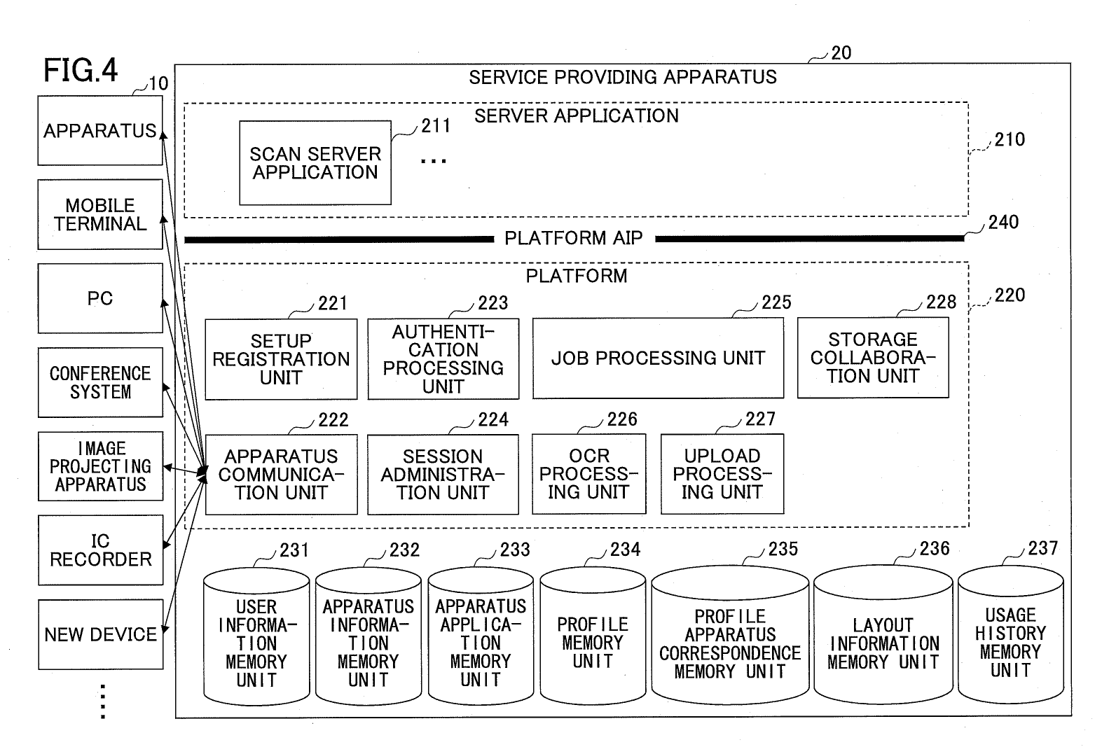

FIG. 4 illustrates an exemplary functional structure of the service providing apparatus 20 of the embodiment. Referring to FIG. 4., the service providing apparatus 20 includes software such as a server application 210 and a platform 220. The server application 210, the platform 220, and so on are formed by at least one program installed on the service providing apparatus 20 and causes the CPU to perform a predetermined process.

The service providing apparatus 20 uses a user information memory unit 231, an apparatus information memory unit 232, an apparatus application memory unit 233, a profile memory unit 234, a profile apparatus correspondence memory unit 235, a layout information memory unit 236, a usage history memory unit 237, or the like. The user information memory unit 231, the apparatus information memory unit 232, the apparatus application memory unit 233, the profile memory unit 234, the profile apparatus correspondence memory unit 235, the layout information memory unit 236, the usage history memory unit 237 and so on can be substantialized by the auxiliary memory device 202, a memory device connected to the service providing apparatus 20 through the network, or the like.

The server application 210 is an application program which performs a service provided by the service providing apparatus 20. However, the service is not completely provided by only the server application 210. By collaboration of the server application 210 and the apparatus 10, the service is completely provided. Further, there is a service completely provided by collaboration with another cloud service such as an online storage. The terminology of “server application” is used for convenience in distinguishing from an application program (e.g., a scanning apparatus application 125, described below) that is required to be installed on a side of the apparatus 10 so that the application program on the side of the service providing apparatus 20 collaborates with the server application 210.

Referring to FIG. 4, a scan server application 211 is illustrated as an example of the server application 210. The scan server application 211 is the server application 210 that performs a process related to the ScanToStorage service.

The platform 220 includes a function commonly used by multiple server applications 210, a basic function used by the multiple server applications 210, or the like. Referring to FIG. 4, the platform 220 includes a setup registration unit 221, an apparatus communication unit, an authentication processing unit 223, a session administration unit 224, a job processing unit 225, an OCR processing unit 226, an upload processing unit 227, a storage collaboration unit 228, or the like. Functions of these units are publicly notified (unveiled) for the server application 210 through the platform API 240. Said differently, the server application 210 can use the functions of these units within a range unveiled by the platform API 240.

The setup registration unit 221 performs a setup registration process required at a time of starting to use a service provided by the service providing apparatus 20 such as the ScanToStorage service. By the setup registration unit 221, information is registered to the user information memory unit 231, the apparatus information memory unit 232, the profile memory unit 234, and the profile apparatus correspondence memory unit 235.

The service information memory unit 231 stores information related to a service served by the service providing apparatus 20. The apparatus information memory unit 232 stores information related to the apparatus 10 collaborating with the service served by the service providing apparatus 20 in a system environment (i.e., the user environment E1) for the user. Said differently, the service provided by the service providing apparatus 20 such as the ScanToStorage service is substantialized by the collaboration with the apparatus 10 in the user environment E1.

The apparatus application memory unit 233 stores an application program (hereinafter, referred to as an “apparatus application”) which is required to be installed on the apparatus so that the server application 210 collaborates with the apparatus 10. The profile memory unit 234 stores a profile. The profiles includes definition information of a composition element of the operation screen of the apparatus application, definition information related to a process performed in response to an operation onto the operation screen, or the like. The profile apparatus correspondence memory unit 235 stores correspondence information between the profile and the apparatus 10. Said differently, it is possible to associate different profiles with the operation screen for the same apparatus application for every apparatus 10. The layout information memory unit 236 stores information indicative of a layout (an arrangement) of the composition elements of the operation screen generated based on the profile. The usage history memory unit 237 stores information indicative of a usage situation for each button provided on the operation screen.

The apparatus communication unit 222 controls a communication with the apparatus 10. The authentication processing unit 223 performs an authentication of a user of the administrator terminal 30 or a user of the apparatus 10 or the like. Further, the authentication processing unit 223 alternatively performs a login process of logging in the online storage system 40 at a time of executing the ScanToStorage service, for example. The session administration unit 224 administrates communication sessions of the service providing apparatus 20 and the apparatus 10 when the service providing apparatus 20 and the apparatus 10 collaborate.

The job processing unit 225 uses the OCR processing unit 226 or the upload processing unit 227, for example, to control the execution of the job required from the server application 210. The OCR processing unit 226 executes an OCR process for the image data to be processed in a case where the job required from the server application 210 is an OCR process. The upload processing unit 227 executes upload in a case where the job required from the server application 210 is the upload of the data through the network. Storage of the data in the online storage system 40 is one mode of the upload.

The storage collaboration unit 228 performs the collaboration with the online storage system 40.

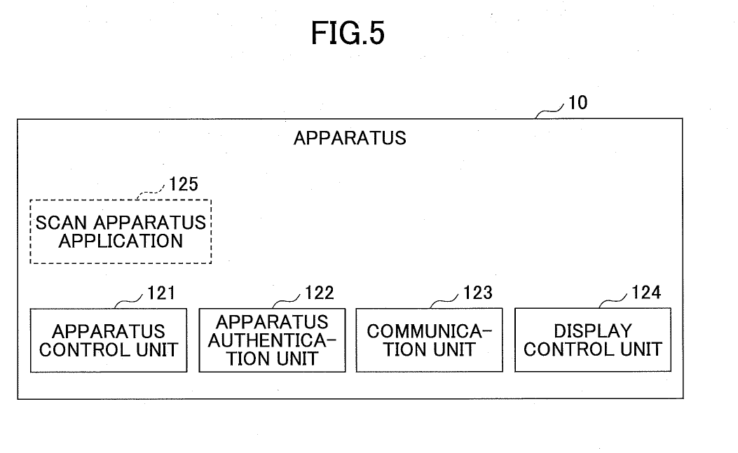

FIG. 5 illustrates an exemplary functional structure of the apparatus of the embodiment. Referring to FIG. 5, the apparatus 10 includes an apparatus control unit 121, an apparatus authentication unit 122, a communication unit 123, a display control unit 124, and so on. These units are substantialized when one or more programs installed in the apparatus 10 are executed by the CPU 111.

The apparatus controlling unit 121 controls hardware of the apparatus 10. The apparatus authentication unit 122 performs a process for authenticating an operator of the apparatus 10. The communication unit 123 controls a communication through the network. The display control unit 124 performs a display of a screen of the operation panel 15 or the like.

Referring to FIG. 5, the scan apparatus application 125 is indicated by a broken line. The scan apparatus application 125 is one of the apparatus applications and is installed on the apparatus 10 so that the apparatus 10 collaborates with the service providing apparatus 20 in the ScanToStorage services. It is sufficient that the apparatus application can be installed on the apparatus 10. The apparatus application functioning as the apparatus application and further functioning as the server application may be installed on the apparatus 10 as the apparatus application.

Within the embodiment, the scanning apparatus application 125 is not originally installed on the apparatus 10, and is installed on the apparatus 10 in a preparation operation for using the ScanToStorage service. Because of this, the scanning apparatus application 125 is indicated by using the broken line. However, the scanning apparatus application 125 may be originally installed on the apparatus 10.

Hereinafter, the procedure performed by the information processing system 1 is described. In order to enable a use of the ScanToStorage service in the user environment E1, it is required to perform a preparation operation such as a registration of various information related to the user environment E1 for the service providing apparatus 20, an installation of the scanning apparatus application 125 onto the apparatus 10, or the like. Therefore, a procedure performed along with the preparation operation is described. The preparation operation is performed by an administrator (hereinafter, simply referred to as an “administrator”) of the apparatus 10 in the user environment E1.

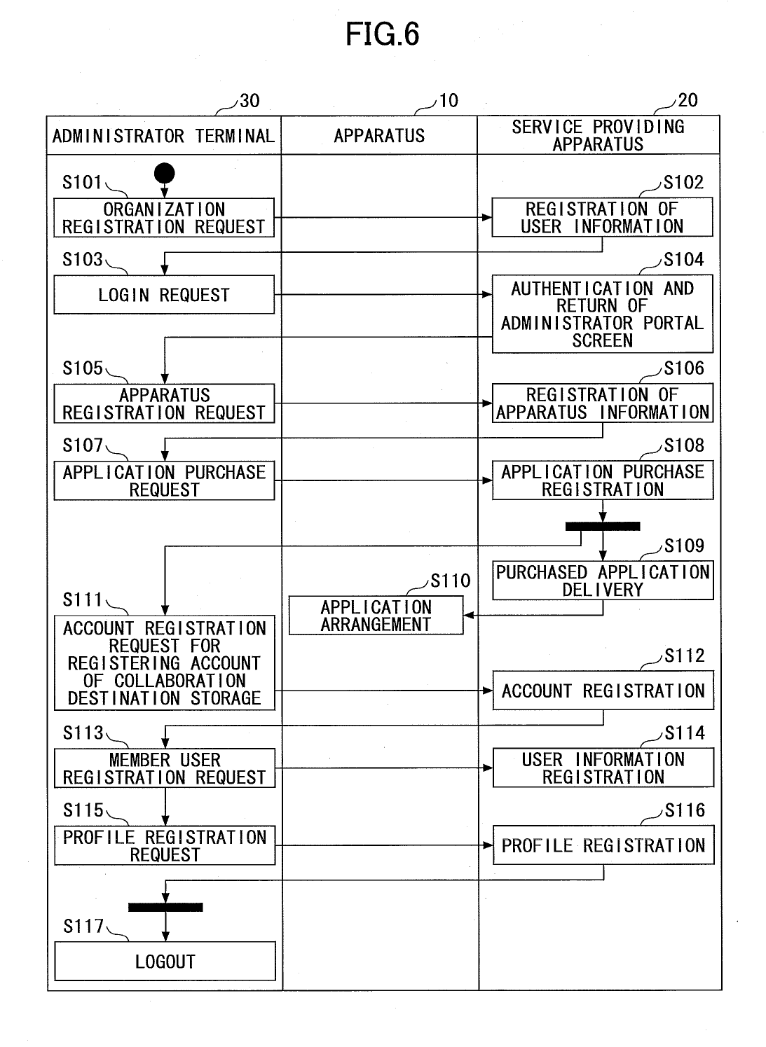

FIG. 6 illustrates an exemplary process performed along with the preparation operation.

In step S101, the administrator terminal 30 sends an organization registration request to the service providing apparatus 20 in response to an instruction input by the administrator. The organization registration request requests a registration of information related to an organization using a service provided by the service providing apparatus 20. The organization registration request is instructed through, for example, the following screen.

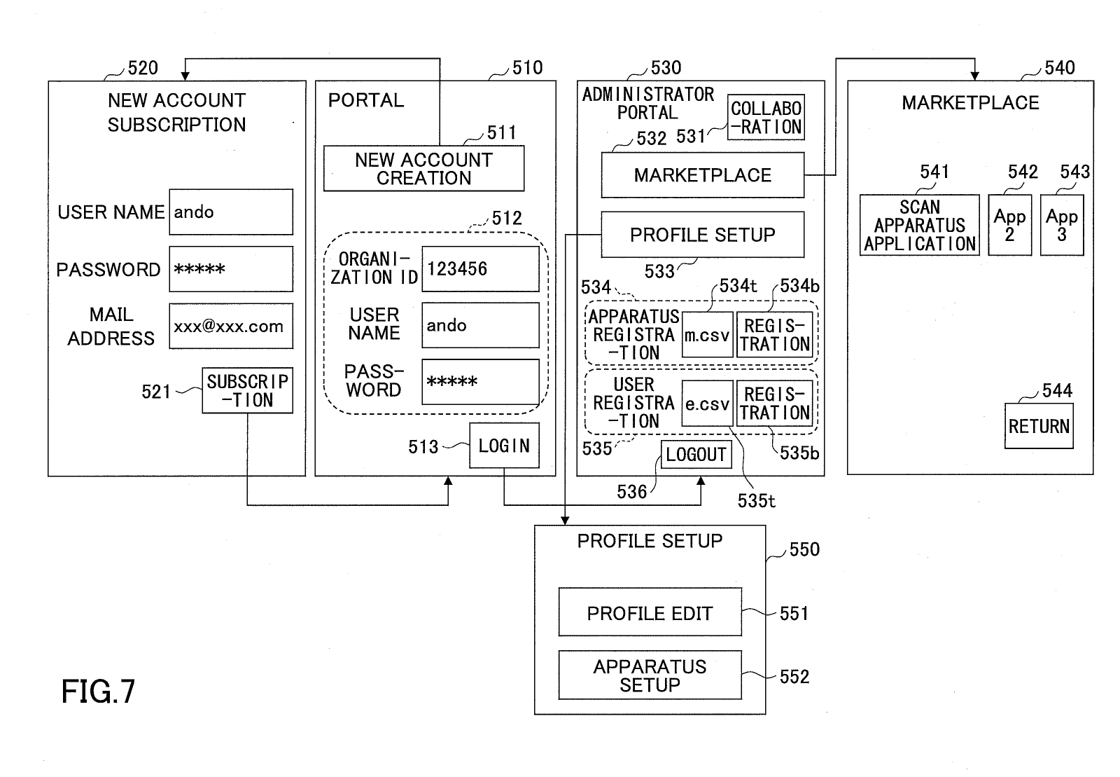

FIG. 7 illustrates an exemplary screen transition displayed on an administrator terminal at a time of the preparation operation. At a time of starting the preparation operation, a portal screen 510 (FIG. 7) is displayed on the administrator terminal 30. The portal screen 510 is an entrance for the service provided by the service providing apparatus 20. Various screens illustrated in FIG. 7 are displayed based on screen data provided by, for example, the service providing apparatus 20. The screen data include HyperText Markup Language (HTML), Cascading Style Sheets (CSS), a script, or the like. Although it is omitted in the following description for convenience, a HyperText Transfer Protocol (HTTP) communication is performed between the administrator terminal 30 and the service providing apparatus 20 at a time of transiting to the screens. The screens illustrated in FIG. 7 are displayed by a process of causing the administrator terminal 30 to perform based on the screen data of the screens by the web browser installed in the administrator terminal 30.

The portal screen 510 includes a new account creation button 511, a login information input area 512, a login button 513, and so on.

In a case where the organization registration is performed, the administrator pushes the new account creation button 511 for making the new account. When the administrator pushes the new account creation button 511 is pushed, a new account subscription screen 520 for subscribing a new account is displayed on the administrator terminal 30. Referring to FIG. 7, each arrow from one screen to another screen designates a transition of an object to be displayed to the other screen by the pushing of the button.

In the new account subscription screen 520, when the user name, the password, and the mail address of the administrator are input and a subscription button 521 is pushed, the administrator terminal 30 sends the organization registration request including the user name, the password, the mail address, and so on to the service providing apparatus 20.

When the organization registration request is received by the service providing apparatus 20, the setup registration unit 221 registers information or the like included in the organization registration request into the user information memory unit 231 (step S102).

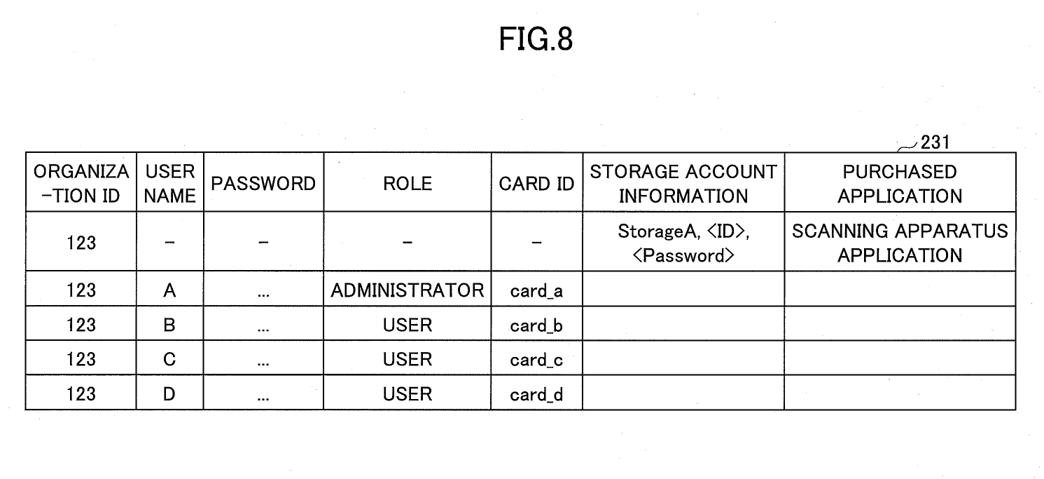

FIG. 8 illustrates an exemplary structure of the user information memory unit. Referring to FIG. 8, each record of the user information memory unit 231 includes items such as an organization ID, a user name, a password, a role, a card ID, storage account information, a purchased application, and so on.

The organization ID is an identifier allocated for each user environment E1, namely, each organization such as an enterprise user using a service provided by the service providing apparatus 20. The user name, the password, the role, and the card ID are of an individual user (hereinafter, referred to as a “member user”) who are a member of the organization related to the organization ID.

The role is an item for identifying the administrator out of the member users. Said differently, the “administrator” is registered as the member user who is the administrator, and the “user” is registered as the member user who is the user. The card ID is an identifier of an IC card used when the member user logs in the apparatus 10. The storage account information is account information for the online storage used by the organization indicated by the organization ID. This account information is used as authorization information presented to the online storage system 40 at a time of storing the image data scanned by the apparatus 10 in the online storage system 40. The purchased application is a view of application identifiers (hereinafter, referred to as an “application ID”) purchased by the organization related to the organization ID. Referring to FIG. 8, the names of the applications are described for convenience, the application ID may be an enumeration of numbers, alphabets, or the like.

A record of which user name is not stored in the user information memory unit 231 is a record (hereinafter, referred to as an “organization record”) corresponding to the organization (the user environment E1). A record of which user name is stored is a record (hereinafter, referred to as a “member record”) corresponding to the member user. Among the member records, a record of which role is the administrator is hereinafter referred to as an “administrator record”, and a record of which role is the user is hereinafter referred to as a “user record”. Within the embodiment, the storage account information and the purchased application are items effective in the organization record. However, the storage account information may be effective in the member record. For example, the storage account information may be set in association with each administrator record, or the storage account information may be set in association with each user record.

In step S101, one organization record and one administrator record are generated. An organization ID is registered in the organization record. Said differently, the organization ID is allocated to the organization record when the organization record is generated. The organization ID, the user name, the password, the role, and so on are registered in the administrator record. In the organization ID of the administrator record, the same value as the organization ID of the generated organization record is registered. A user name or a password included in the organization registration request is registered in the user name and the password. The “administrator” is registered in the role.

The other items of the organization record and the administrator record, the user record, and so on are registered or generated in the process described later.

Subsequently, the setup registration unit 221 sends an e-mail (hereinafter, referred to as a registration reporting mail) reporting, for example, that the organization registration is normally completed to a mail address included in the organization registration request. For example, the allocated organization ID is included in the registration reporting mail. However, the normal completion of the organization registration may be included in an HTTP response for an HTTP request including, for example, the organization registration request. Further, the organization ID may be designated on a new account subscription screen 520 by the user.

When the organization registration is normally completed, the administrator inputs the registered organization ID, the registered user name, and the registered password into a login information input area 512 of a portal screen 510, and pushes a login button 513. In response to the push of the login button 513, the administrator terminal 30 sends a login request to the service providing apparatus 20 (step S103). The organization ID, the user name, and the passwords which are input in the login information input area 512 are included in the login request.

The authentication processing unit 223 of the service providing apparatus 20 authenticates the user who requests the login request based on whether a record, which has the login ID, the user name, and the password included in the login request and a value of which role is the “administrator”, is stored in the user information memory unit 231 in response to the login request. In a case where the proper record is stored, the authentication is successful (step S104). In a case where the proper record is not stored, the authentication fails. In the case where the authentication is successful, the setup registration unit 221 returns a Web page displaying a portal screen (hereinafter, an “administrator portal screen 530”) exclusively used for the administrator having the user name included in the login request. Hereinafter, the administrator who has logged in is referred to as a “login administrator”.

The administrator terminal 30 causes the administrator portal screen 530 to be displayed based on the returned web page. Referring to FIG. 7, the administrator portal screen 530 includes a collaboration button 531, a marketplace button 532, a profile setup button 533, an apparatus registration area 534, and a user registration area 535.

Here, the administrator inputs a file name of a file (hereinafter referred to as an “apparatus information file”), in which information (hereinafter referred to as “apparatus information”) related to the apparatuses 10 collaborating with the ScanToStorage service into a text box 534t of the apparatus registration area 534, and pushes a registration button 534b.

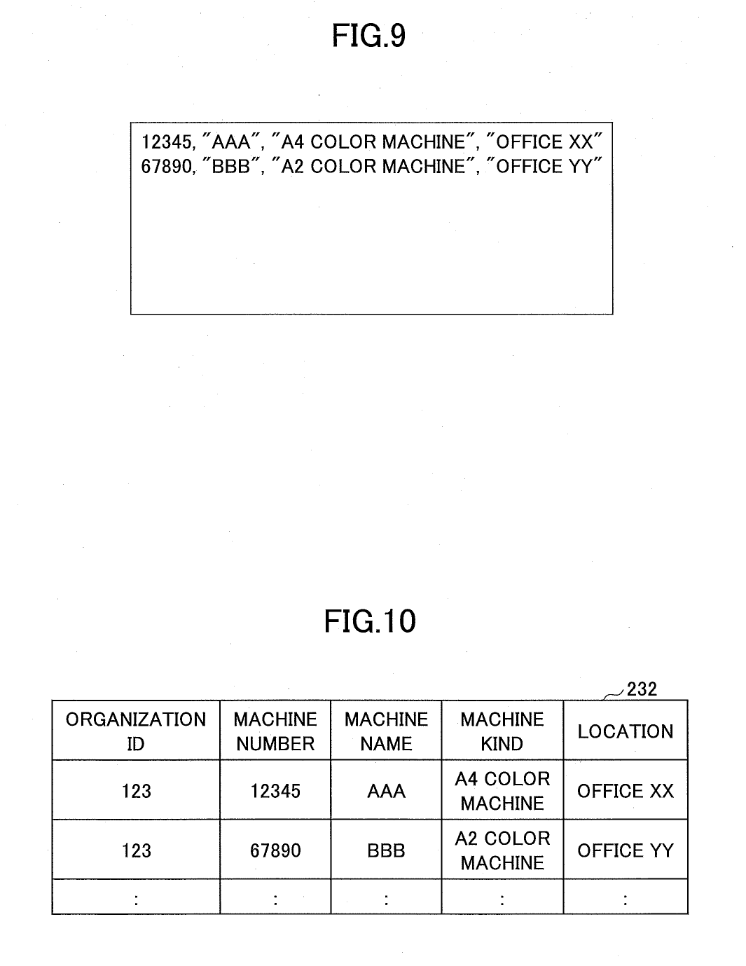

The apparatus information related to one apparatus 10 includes, for example, a machine number, a machine name, a machine kind, a location, and so on. Values of these items are described in the apparatus information file in a format illustrated in, for example, FIG. 9.

FIG. 9 illustrates an exemplary description of apparatus information in the apparatus information file. Referring to FIG. 9, the apparatus information is described in a Comma Separated Values (CSV) format where the values of the items are separated by commas, as an example. However, the description format of the apparatus information in the apparatus information file is not limited to the CSV format. The description format may be an eXtensible Markup Language (XML) format or another format.

The machine number is identification information of a machine (an individual piece) of each apparatus 10. For example, a manufacturing number or a serial number may be used as the machine number. The machine name has the same meaning as a model name. The machine kind is information simply indicating the function of a model concerning the model name. The location indicates a place where the apparatus 10 is installed in the user environment E1.

When the file name of the apparatus information file is input in the text box 534t and the registration button 534b is pushed, the administrator terminal 30 sends a registration request including the apparatus information described in the apparatus information file to the service providing apparatus 20 (step S105).

The setup registration unit 221 of the service providing apparatus 20 registers the apparatus information included in the apparatus registration request in association with the organization ID related to the login administrator when the apparatus registration request is received (step S106).

FIG. 10 illustrates an exemplary structure of the apparatus information memory unit. Referring to FIG. 10, the apparatus information memory unit 232 stores a record for each apparatus 10. Each record includes items such as the organization ID, the machine number, the machine name, the machine type, the location, and so on. The apparatus information memory unit 232 maintains the association between the apparatuses 10 and the organization 10.

Subsequently, the administrator push the market place button 532 of the administrator portal screen 530 (FIG. 7) in order to purchase the scan apparatus application 125, which is an apparatus application required to be installed in the apparatus 10 to enjoy the ScanToStorage service. In response to the push of the market place button 532, a market place screen 540 is displayed on the administrator terminal 30.

As illustrated in FIG. 7, the market place screen 540 includes a button for each apparatus application stored in the apparatus application memory unit 233. FIG. 7 illustrates an example of including the buttons 541, 542, and 543 corresponding to three apparatus applications. The button 541 is a button corresponding to the scan apparatus application 125.

Here, the scanning apparatus application 125 is an object of the purchase, the button 541 is pushed by the administrator. In response to the push of the button 541, the administrator terminal 30 sends an application purchase request including the application ID of the scanning apparatus application 125 to the service providing apparatus 20 (step S107).

When the setup registration unit 221 of the service providing apparatus 20 receives the application purchase request, the setup registration unit 221 stores an application ID included in the application purchase request into the item of the purchased application included in the user information memory unit 231 as the organization record corresponding to the organization ID corresponding to the login administrator (step S108). For example, referring to FIG. 8, the “scan apparatus application” in the item of the purchased application of the organization application corresponding to the organization ID equal to “123” is registered at this timing.

Subsequently, the apparatus communication unit 222 acquires the scan apparatus application 125 corresponding to the application ID included in the application purchase request from the apparatus application memory unit 233 and delivers the acquired scanning apparatus application 125 to the apparatus 10 belonging to the login administrator of the source of the application purchase request (step S109). The apparatus 10 belonging to the organization ID is the apparatus 10 corresponding to the organization ID in the apparatus information memory unit 232.

Ordinarily, because a firewall is installed in the user environment E1, it is impossible to send the scan apparatus application 125 from the service providing apparatus 20 to the apparatuses 10 inside the user environment E1. Therefore, for example, the scan apparatus application 125 may be returned in response to a polling from the communication unit 123 of the apparatus 10.

Said differently, the IP address of the service providing apparatus 20, a port number for the apparatus communication unit 222, or the like is set to the apparatus 10 to collaborate with the service providing apparatus 20. The communication unit 123 of each apparatus 10 performs polling to periodically inquire of the IP address and the port number about whether any event occurs, for example. This inquiry includes, for example, a machine number. The apparatus communication unit 222 of the service providing apparatus 20 returns the scan apparatus application 125 if the machine number designated in the inquiry is the machine number associated with the organization ID of the purchase source of the scanning apparatus application 125.

However, in a case where no firewall exists between the user environment E1 and the service providing apparatus 20, the apparatus communication unit 222 may send the scanning apparatus application 125 to each apparatus 10. In this case, the IP address, the port number, or the like of the apparatus 10 may be included in the apparatus information stored in the apparatus information memory unit 232.

Each apparatus 10 receiving the scan apparatus application 125 arranges (installs) the scanning apparatus application 125 on the inside of the apparatus 10 (step S110).

Subsequently, when a return button on the market place screen 540 is pushed by the administrator, the market place screen 540 is not displayed and the administrator portal screen 530 is displayed on the administrator terminal 30.

Instead of steps S103 to S110, the following operation and process may be performed.

For example, the scanning apparatus application 125 is asynchronously purchased with the procedure illustrate in FIG. 6 and installed in the apparatus 10. The scan apparatus application 125 may be purchased using a predetermined web site or the like.

When the scan apparatus application 125 is started up at a time of starting up the apparatus 10 which is the install destination of the scan apparatus application 125, the scan apparatus application 125 automatically sends a registration request (hereinafter, an “automatic registration request”), in which the organization ID, the user name and the password of the administrator, the apparatus information of the apparatus 10, and the application ID or the like of the scan apparatus application 125, and so on are designated, to the service providing apparatus 20. Meanwhile, the organization ID, the user name of the administrator, and the password are input in the administrator terminal 30 and set to the apparatus 10 through the network. When the setup registration unit 221 of the service providing apparatus 20 receives the automatic registration request, the setup registration unit 221 authenticates the organization ID designated in the automatic registration request, the user name of the administrator, and the password. The authentication process may be similar to the process described in step S103. When the authentication is successful, the setup registration unit 221 registers the organization ID designated in the automatic registration request and the apparatus information in the apparatus information memory unit 232 by associating these. Further, the setup registration unit 221 stores the application ID designated in the automatic registration require into the item of the purchased application of the user information memory unit 231 while associating the application ID with the organization ID designated in the automatic registration request. With this procedure, the organization ID and the apparatus information can be associated, and the organization ID and the application ID can be associated.

Further, instead of the user name and the password of the administrator, an apparatus certificate may be designated in the automatic registration request. The apparatus certificate is an electronic certificate of the apparatus 10, which is data certifying that the apparatus 10 is an authorized product. The apparatus certificate is previously stored in the apparatus 10. In this case, the setup registration unit 221 of the service providing apparatus 20 checks the authenticity of the apparatus certificate. After the setup registration unit 221 successfully checks the authenticity of the apparatus certificate, the setup registration unit 221 associates the organization ID with the apparatus information and registers these in the apparatus information memory unit 232.

Further, the automatic registration request may also perform the organization registration request illustrated in step S101. Said differently, an organization record, an administration record, or the like may be stored in the user information memory unit 231 in response to the automatic registration request.

Subsequently, the administrator pushes the collaboration button 531 on the administrator portal screen 530 in order to register the account information for the online storage system 40 with which the collaboration is performed in the ScanToStorage service. In response to the push of the collaboration button 531, the administrator terminal 30 displays a storage collaboration screen 610.

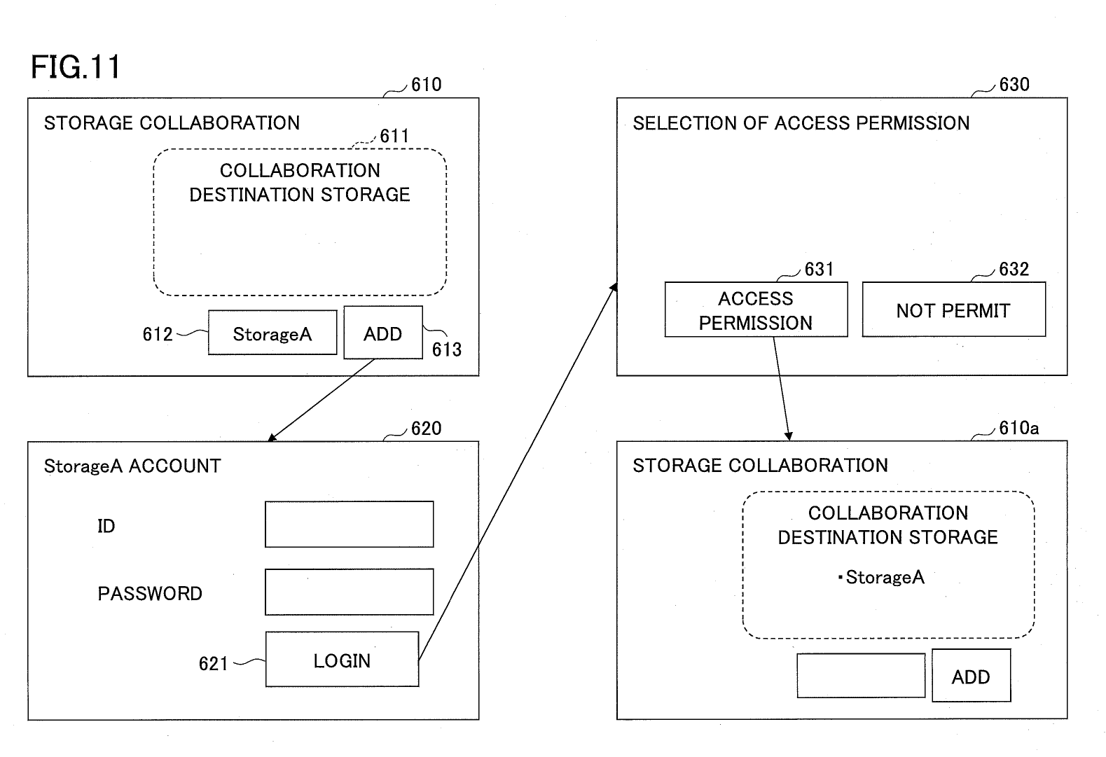

FIG. 11 illustrates an exemplary screen transition for causing the account information of the online storage system of the collaboration destination to be registered.

Referring to FIG. 11, the storage collaboration screen 610 includes a collaboration destination storage display area 611, a collaboration destination input area 612, an add button 613, and so on. A collaboration destination storage display area 611 displays a name (hereinafter, a “storage name”) of the online storage system 40 selected as the collaboration destination. If the online storage system 40 selected as the collaboration destination already exists, the storage name of this online storage system 40 is displayed. A collaboration destination input area 612 is provided to receive an input of the storage name of the online storage system 40 (hereinafter, referred to as a “collaboration destination storage”).

When the storage name (“StorageA”) is input in the collaboration destination input area 612 and the add button 613 is pushed, the account input screen 620 is displayed on the administrator terminal 30. The administrator terminal 30 receives an input of the account information (an ID (e.g., a mail address) and a password) for the collaboration destination storage from the administrator through the account input screen 620. The account information is previously made by a user registration or the like for the collaboration destination storage. When the ID and the password are input in the account input screen 620 and the login button 621 is pushed, the administrator terminal 30 logs in the collaboration destination storage (“StorageA”) based on the ID and the password. The Uniform Resource Locator (URL) of a destination of requesting the login to the collaboration destination storage may be previously stored in the administrator terminal 30 in association with the storage name, or the URL may be input on the collaboration destination input area 612.

If the login is successful, the administrator terminal 30 displays a screen 630 for a selection of an access permission. The screen 630 for the selection of the access permission is provided to select whether an access of the service providing apparatus 20 to the collaboration destination storage is permitted or not. If a button 632 (“not permit”) is pushed, the display screen on the administrator terminal 30 transits to the administrator portal screen 530. If a button 631 (“access permission”) is pushed, the administrator terminal 30 sends an account registration request for registering an account of the collaboration destination storage to the service providing apparatus 20 (step S111). The account registration request includes the storage name input into the storage collaboration screen 610 and account information (the ID and the password) input into the account input screen 620.

When the request for account registration is received by the setup registration unit 221 of the service providing apparatus 20, the setup registration unit 221 registers the storage name, the ID, and the password included in the request into the storage account information of the organization record corresponding to the organization ID corresponding to the login administrated (step S112), which storage account information is stored in the user information memory unit 231 (FIG. 8). FIG. 8 illustrates an example where the storage name of Storage A and the ID and the password for StorageA are registered in the organization record whose organization ID is “123”.

The collaboration destination storage and the account information for the collaboration destination storage may be set for each user. In this case, an area to which one or more user names can be input may be provided in, for example, the storage collaboration screen 610 or the account input screen 620. The user name input in the area is included in the account registration request and sent to the service providing apparatus 20. The setup registration unit 221 of the service providing apparatus 20 registers the storage name, the ID, and the password in the storage account information of the member record corresponding to the user name included in the account registration request.

If the service providing apparatus 20 successfully registers the storage name, the ID, and the password in the storage account information in response to the account registration request, the administrator terminal 30 displays a storage collaboration screen 610a. The storage name of the collaboration destination storage is displayed on the collaboration destination storage display area 611 of the storage collaboration screen 610a. Subsequently, the account information of another online storage and so on may be registered. Said differently, account information for the multiple online storages may be registered with respect to one organization record or one member record.

Subsequently, the administrator registers the member user who is permitted to use the ScanToStorage service in the user environment E1. Specifically, the administrator inputs the file name of a file (hereinafter, a “user information file”), in which information (hereinafter, “user information”) of a member user is described in the text box 535t of the user registration area 535 on the administrator portal screen 530 (see FIG. 7), and pushes a registration button 535b.

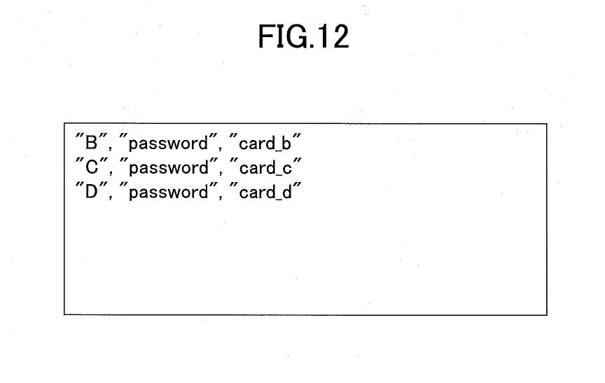

The user information of one member user is, for example, items such as the user name, the password, the card ID, and so on. Values of these items are described in the user information file in a format illustrated in, for example, FIG. 12.

FIG. 12 illustrates an exemplary description of user information in a user information file. Referring to FIG. 12, the user information is described in a CSV format where values of items are separated by commas. However, the description format of the user information in the user information file is not limited to the CSV format. The description format may be an eXtensible Markup Language (XML) format or another format.

When the file name of the user information file is input in the text box 535t and the registration button 535b is pushed, the administrator terminal 30 sends a user registration request including the user information described in the user information file to the service providing apparatus (step S113).

The setup registration unit 221 of the service providing apparatus 20 associates the user information included in the user registration request with the organization ID corresponding to the login administrator, and registers the user information in the user information memory unit 231 (step S114). Said differently, a new user record is generated for each user information and one user information is registered for each user record. In the example illustrated in FIG. 8, records of which user names are respectively B, C, or D are registered in step S114. The user information of the administrator may be included in the user registration request. In this case, the user information of the administrator is user information of which user name matches the user name of the administrator record. In this case, the content of the administrator record may be updated by the user information included in the user registration request. Further, the card ID of the administrator may be registered at this timing, for example.

Subsequently, when the ScanToStorage service is used, the administrator performs a setup operation of a profile, which is structural information of the operation screen displayed on the operation panel 15 of each apparatus 10 or the like. The profile of this embodiment includes information of the operation screen of the scan apparatus application 125 and information of read conditions of scanning for each button on the operation screen, a work processing for the scanned image data, and a storage as a storage destination (a delivery destination), and so on.

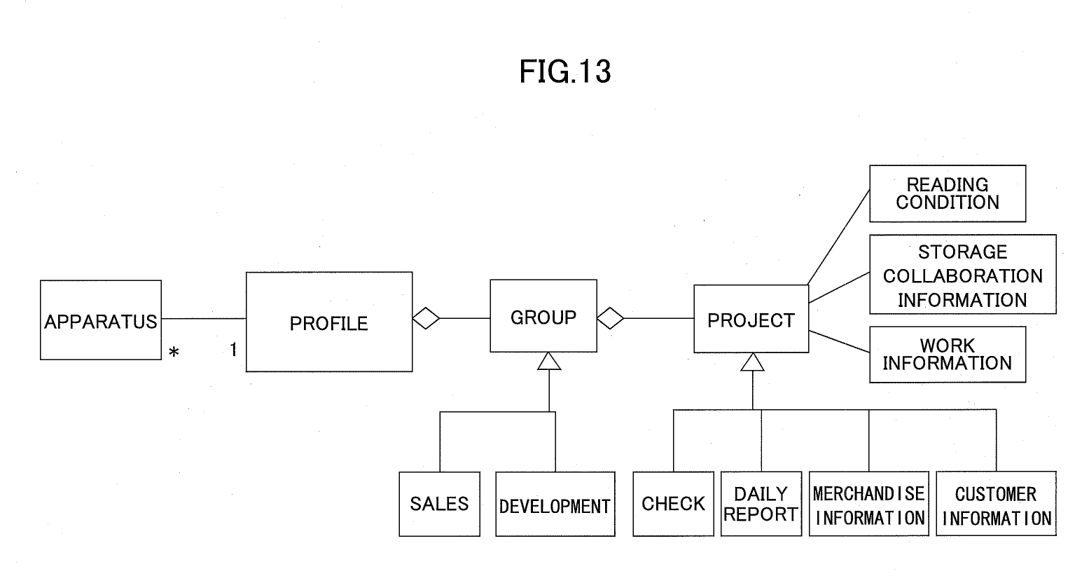

FIG. 13 is a diagram for explaining a conceptual model of the profile. As illustrated in FIG. 13, each apparatus 10 includes one profile. However, the profiles may be different for different apparatuses 10. For example, different profiles may be set for different users in the single apparatus 10.

The profile includes at least one group. The group is a concept corresponding to, for example, a tab window in the operation screen. Referring to FIG. 13, “sales” and “development” are illustrated as a specific example of the group. These indicate a sales tab window and a development tab window, respectively.

The profile includes at least one group. The project is a concept corresponding to an operation piece such as a button arranged on the tab window. Referring to FIG. 13, “check”, “dairy report”, “merchandise information”, and “customer information” are illustrated as a specific example of the project. These illustrate labels of the buttons arranged on the sales tab window.

One project includes reading condition, storage collaboration information, work information, a storage collaboration source, and so on or is associated with these information. The reading condition is a condition in reading at a time of scanning. The storage collaboration information indicates which folder in which online storage system 40 is determined as the storage destination for the scanned image data and so on. The work information relates to a work processing (an image processing) performed for the scanned image data before storing the scanned image data.

When the profile setup button 533 is pushed on the administrator portal screen 530 illustrated in FIG. 7, a profile setup screen 550 is displayed on the administrator terminal 30. Referring to FIG. 7, the profile setup screen 550 includes a profile edit button 551 and an apparatus setup button 552. Subsequently, if the apparatus setup button 552 of the profile setup screen 550 (FIG. 7) is pushed by the administrator, the administrator terminal 30 displays the profile apparatus setup screen 720.

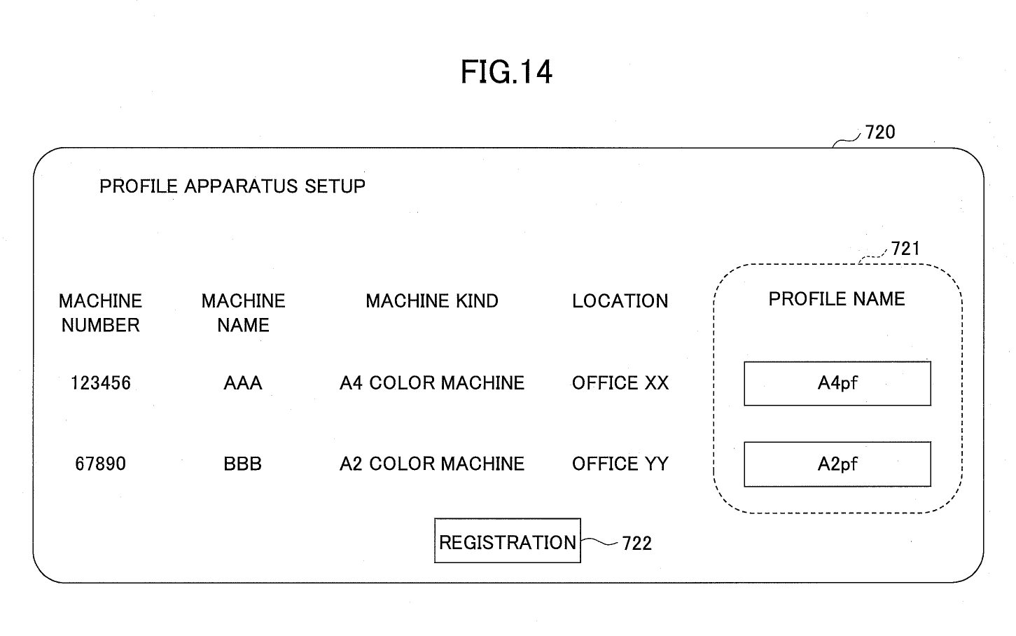

FIG. 14 illustrates an exemplary display of the profile apparatus setup screen 720. The profile apparatus setup screen 720 is provided to set up a correspondence between the profile and the apparatus 10. Referring to FIG. 14, the profile apparatus setup screen 720 displays the apparatus information and a profile name input area 721 for each apparatus 10 whose apparatus information is stored on the apparatus information memory unit 232 in association with the organization ID related to a login administrator. The administrator inputs the profile name of the profile associated with (used by) each apparatus 10 into the profile name input area 721 and pushes a registration button 722. Within this embodiment, the profile is not made by this time. Therefore, a profile name planned to be given to the profile to be made is input. In a case where the profile is previously made, the profile name of the profile may be input.

In response to the push of the registration button 722, the administrator terminal 30 sends a registration request including the setup contents (e.g., a combination of the machine number and the profile name) on the profile apparatus setup screen 720 to the service providing apparatus 20. The setup registration unit 221 of the service providing apparatus 20 registers the information included in the registration request into the profile apparatus correspondence memory unit 235.

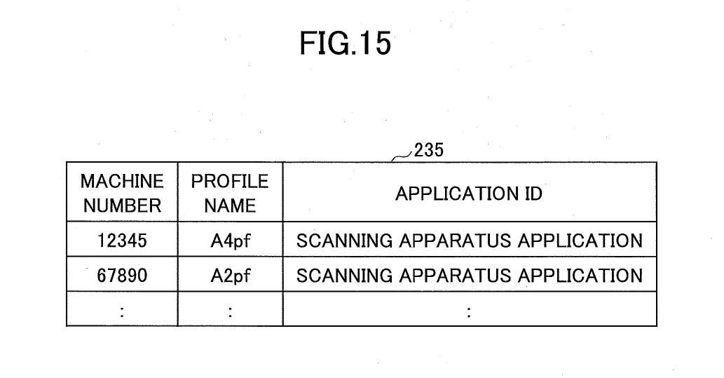

FIG. 15 illustrates a structural example of the profile apparatus correspondence memory unit. The profile apparatus correspondence memory unit 235 stores the machine number, the profile name, and the application ID of the apparatus application while associating the machine number, the profile name, and the application ID. The associated application ID is of the apparatus application selected on the marketplace screen 540. Said differently, the setup registration unit 221 stores the application ID of the apparatus application in the memory device 203 or the like in association with the login administrator, and the application ID is stored into the profile apparatus correspondence memory unit 235 in association with the setup contents in response to the registration request of the setup contents in the profile apparatus setup screen 720.

Subsequently, when the administrator selects the profile edit button 551, the administrator terminal 30 displays the profile edit screen 710 on the profile setup screen 550. Said differently, screen data of displaying the profile edit screen 710 is downloaded from the 221 of the service providing apparatus 20 and cause the profile edit screen 710 to be displayed based on the screen data. The screen data include a definition using the HTML, a script of Java script (“Java” is a registered trademark), and so on. The definition using the HTML and the script may be included in an identical file or different files.

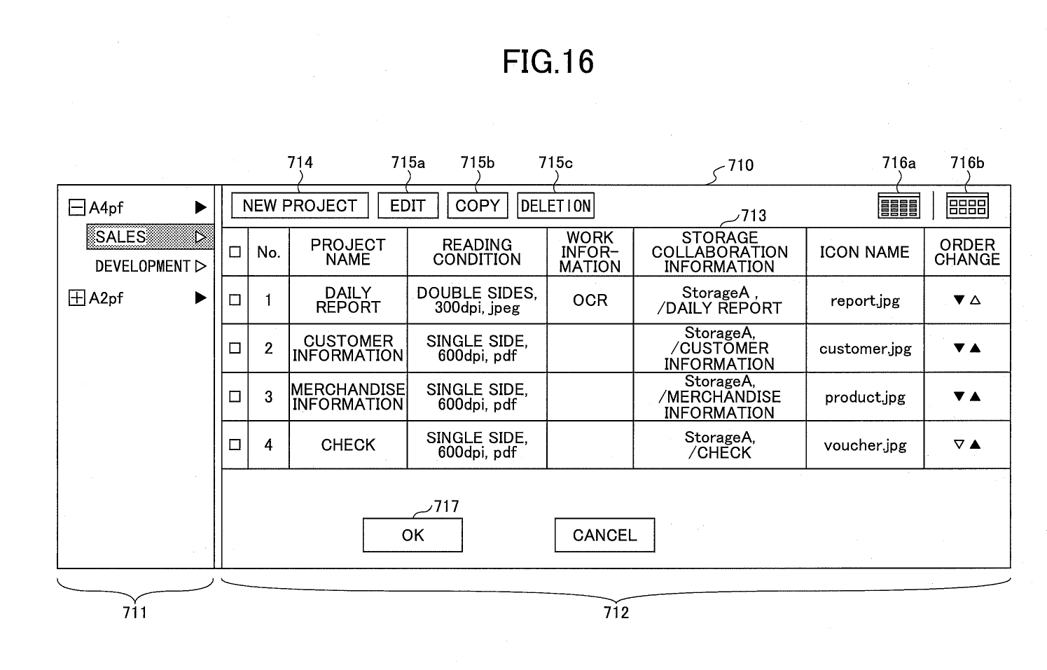

FIG. 16 illustrates an exemplary display of the profile edit screen. Referring to FIG. 16, the profile edit screen 710 includes a tree area 711, a project edit area 712, and so on.

On the tree area 711, displayed is tree parts where the profile is allocated to a node of a first hierarchy and the groups belonging to each of the profiles are allocated to a node of a second hierarchy.

For example, when a right button of, for example, a mouse is clicked on a blank area of the tree area 711, the administrator terminal 30 displays a context menu including a menu item of “adding profile”. When a menu item of “adding profile” is selected, the administrator terminal 30 displays a screen for inputting the profile name and so on. When the profile name is input through the screen, the administrator terminal 30 adds a new node of the first hierarchy related to the input profile name to the tree area 711. Further, when the right button of the mouse is clicked on the node corresponding to any one of the profiles, the administrator terminal 30 displays a context menu including a menu item of “adding group”. When the menu item of “adding group” is selected, the administrator terminal 30 displays a screen for inputting the group name and so on. When the group name is input through the screen, the administrator terminal 30 adds the node corresponding to the group name to a lower part of the node on which the right button is clicked.

The project edit area 712 includes a project view area 713, a new project button 714, an edit button 715a, a copy button 715b, a deletion button 715c, a view display icon 716a, a preview display icon 716b, and an OK button 717, and so on.

On the project view area 713, information related to the project is displayed in a view format for each of the projects belonging to the group selected in the tree area 711. Said differently, one row in the project view area 713 corresponds to one of the projects. When a mark of “▴” or “▾” is operated on the column of “order change” in the project view area 713 is operated, the administrator terminal 30 changes the order of arranging the rows. Specifically, in a case where “▾” is selected, the administrator terminal 30 replaces the row whose “▾” is selected with a row immediately below the row. In a case where “▴” is selected, the administrator terminal 30 replaces the row whose “▴” is selected with a row immediately above the row. The order of the rows corresponds to the order of displaying button corresponding to the projects.

When the new project button 714 is pushed, the administrator terminal 30 adds a new row to the project view area 713.

When the edit button 715a is pushed, the administrator terminal 30 displays a screen (hereinafter, referred to as a “project setup screen”) provided to set the project name, the reading condition, the work information, the storage collaboration information, and the icon name of the project corresponding to the row selected in the project view area 713. The project name is an identification name of the project and also is a label of the button corresponding to the project. Within the embodiment, the project name matches the folder name of the storage collaboration information.

The reading condition relates to a scan performed in a case where the button corresponding to the project is pushed. For example, a side of a sheet to be scanned, a resolution, a file format of a scanned image, and so on are included in the reading condition. Other items such as a color mode may be included in the reading condition.

The work information indicates a work processing performed for the image data scanned in response to the push of the button corresponding to the project. Referring to FIG. 16, Optical Character Recognition (OCR) is indicated as an example of the work processing. In this case, the result of the OCR is to be stored at a storage destination indicated in the storage collaboration information. Instead of the OCR, a translation of the result of the OCR or a conversion of the data format of the image data may be set as the work processing. Further, a setup of combinations of multiple work processings may be enabled.

The storage collaboration information is information related to the storage destination of data which are scanned in response to the push of the button corresponding to the project and subjected to the work processing when necessary. FIG. 16 illustrates an example where the storage name of the online storage as the storage destination and the folder name in the online storage can be set. The storage name selectable as the storage destination is registered in the storage account information of the organization record (FIG. 8) corresponding to the organization ID related to the login administrator. The folder name is a button name “a label” of a button corresponding to the project. Said differently, if the folder name is changed, the button name of the button corresponding to the project is changed. However, it is unnecessary that the button name matches the folder name.

The icon name is a file name of an icon displayed on the button corresponding to the project.

When the reading condition and the storage collaboration information are input in the project setup screen and the work information and the icon name are set depending on necessity, the administrator terminal 30 inputs (reflects) a set value in the row selected in the project view area 713. Alternatively, the project setup screen may be displayed in response to the push of the new project button 714 and a value input onto the project setup screen may be input (reflected) into the newly added row.

When the copy button 715b is pushed, a copy of the row selected in the project view area 713 is added to a row immediately below the row or an end portion of the project view area 713. When the deletion button 715c is pushed, the administrator terminal 30 deletes the row (i.e., the project) selected in the project view area 713.

The view display icon 716a and the preview display icon 716b are an example of an operation piece for receiving an instruction of changing a display format or a display state of the project edit area 712. FIG. 16 illustrates a state where the view display icon 716a is selected. A process performed by the administrator terminal 30 in response to the operation of the profile edit screen 710 is based on a script (a command group) structuring the image data of the profile edit screen 710.

A result of the edit on the profile edit screen 710 is stored in the profile memory unit 234 of the service providing apparatus 20.

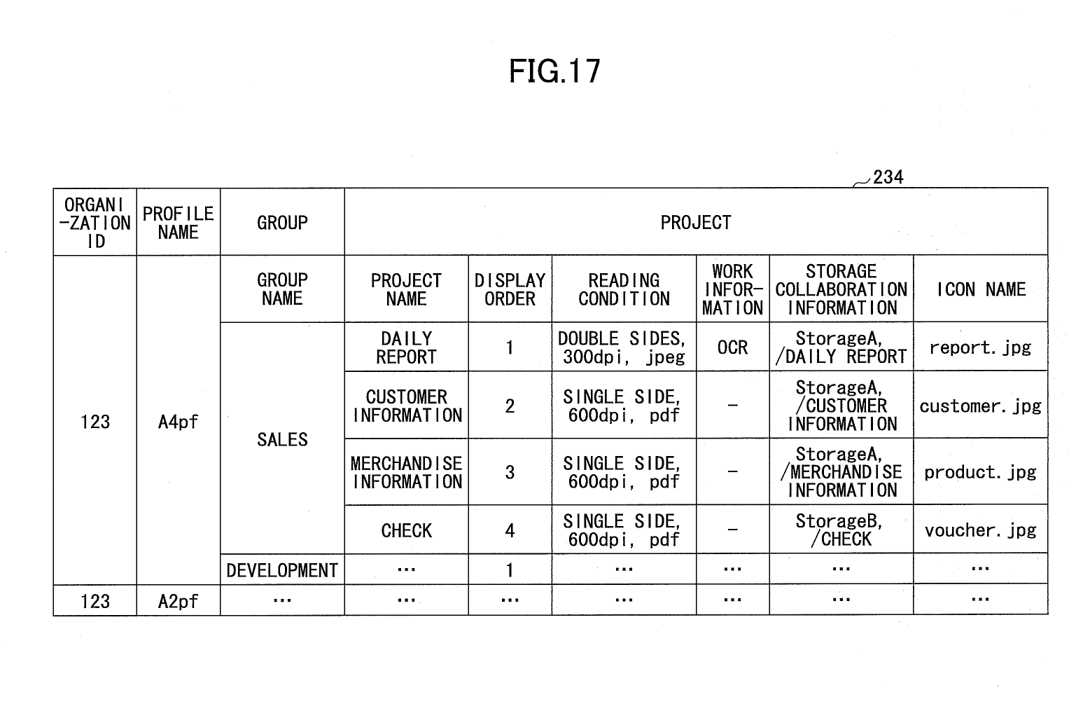

FIG. 17 illustrates a structural example of the profile memory unit 234. The profile memory unit 234 includes items such as the organization ID, the profile name, the group name, and the project for each of the profiles.

The organization ID is an ID of the organization to which the profile belongs. The profile name is a name of the profile. The group name is included in the profile. In the records for one profile, records (hereinafter, referred to as a “group record”) for each of the groups are formed. The project is included in the group. Inside one group record, the records (hereinafter, referred to as a “project record”) for each of the projects are formed.

One group record includes the group name and at least one project record. The group name is an identification name of the group and also a label displayed on a tab of a tab window corresponding to the group.

One project record includes the project name, the display order, the reading condition, the work information, the storage collaboration information, the icon name, and so on. The meaning of these items are as described in the profile editing screen 710 (see FIG. 16).

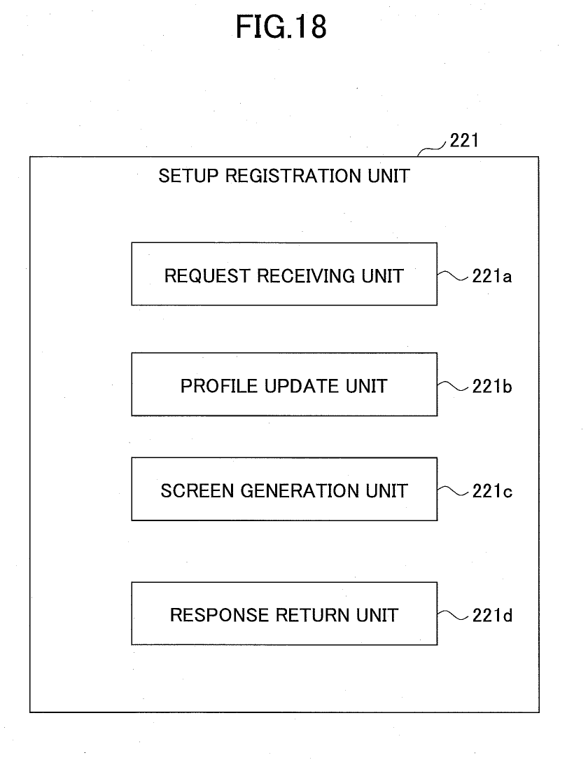

As to the edit of the profile, the setup registration unit 221 has a functional structure as illustrated in, for example, FIG. 18. FIG. 18 illustrates an exemplary functional structure of the setup administration unit for editing the profile. Referring to FIG. 18, the setup registration unit 221 includes a request receiving unit 221a, a profile update unit 221b, a screen generation unit 221c, a response return unit 221d, and so on.

The request receiving unit 221a receives a request sent from the administrator terminal 30 in response to an operation to the profile edit screen 710. When the request from the administrator terminal 30 is a request to update the profile, the profile update unit 221b inputs (reflects) the content of the update request into the profile memory unit 234. Said differently, the profile update unit 221b updates the profile to be updated among the profiles stored in the profile memory unit 234.

The screen generation unit 221c generates the screen data of the profile edit screen 710 based on the profile to be edited, which is stored in the profile memory unit 234. The response return unit 221d returns a response to a request returned by the request receiving unit 221a to the administrator terminal 30. The screen data of the profile edit screen 710 are included in the response when necessary.

For example, the administrator terminal 30 sends an update request) for updating the profile corresponding to the operation to the setup registration unit 221 of the service providing apparatus 20 for each of actions of adding the profile, adding the group, or adding, editing, copying or deleting the project on the profile edit screen 710 (step S115). This is received by the request receiving unit 221a of the setup registration unit 221. The profile update unit 221b of the setup registration unit 221 performs actions of adding the record corresponding to the profile, adding the group record, or adding, editing, copying or deleting the project record on the profile memory unit 234 (step S116) in response to the update request. Therefore, a memory content of the profile memory unit 234 is updated in synchronization with a setup state on the profile edit screen 710. In a case of adding the profile, the profile update unit 221b stores the organization ID corresponding to the login administrator in the organization ID of the record corresponding to the profile.

When the OK button 717 is pushed after completing to edit the profile, the profile edit screen 710 is not displayed.

Operations on the profile edit screen 710 may not be sequentially reported to the setup registration unit 221, and an edit result (a setup content) obtained by editing the profile edit screen 710 may be collectively sent to the setup registration unit 221 when the OK button 717 is pushed.

Subsequently, when the logout button 536 on the administrator portal screen 530 (FIG. 7) is pushed (step S117), the administrator terminal 30 sends a logout request to the service providing apparatus 20. In response to the receipt of the logout request, the service providing apparatus 20 releases the state where the login administrator logging in.

After the above processes, the preparation operation for using the ScanToStorage service is completed by the administrator.

Subsequently, described is a switchover process of the display format of the project edit area 712, which is performed in response to a selection between the view display icon 716a and the preview display icon 716b on the profile edit screen 710.

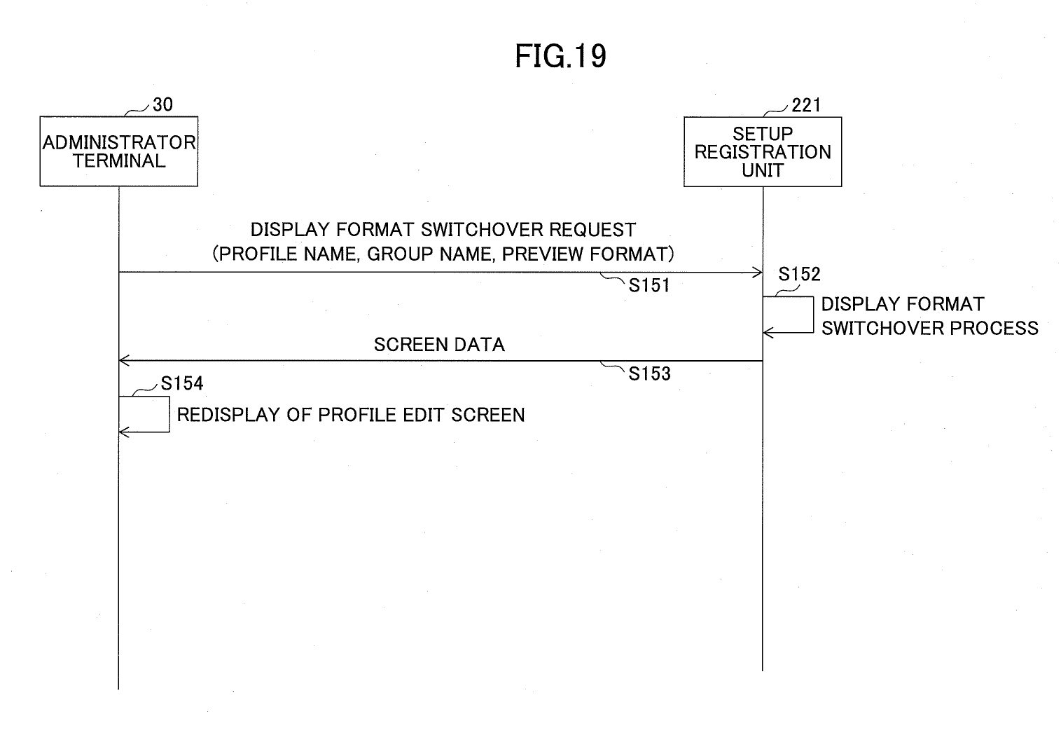

FIG. 19 is a sequence chart for explaining an exemplary process of a switchover process of the display format of a project edit area.

For example, when the preview display icon 716b is selected while the display state of the profile edit screen 710 is as illustrated in FIG. 16, the administrator terminal 30 sends a switchover request of the display format of the project edit area 712 to the setup registration unit 221 of the service providing apparatus 20 (step S151). The switchover request is received by the request receiving unit 221a. This switchover request designates the group name of the group selected on the tree area 711 of the profile edit screen 710, the profile name of the profile to which the group belongs, and the “preview format” indicative of the display format at the switchover destination.

The screen generation unit 221c of the setup registration unit 221 performs a switchover process of switching over the display format of the profile edit screen 710 in response to the switchover request (step S152). As a result, the screen data of the profile edit screen 710 of the switched-over display format are generated. The screen data are generated using, for example, HTML, CSS, a script, or the like. The screen data are generated by using the group record corresponding to the profile name and the group name, which are stored in the profile memory unit 234 and included in the switchover request, information stored in the layout information memory unit 236, or the like. Further, the project edit area 712 is generated so as to have the preview format. The response return unit 221d returns the generated screen data to the administrator terminal (step S153). The administrator terminal 30 displays the profile edit screen 710 again based on the screen data (step S154).

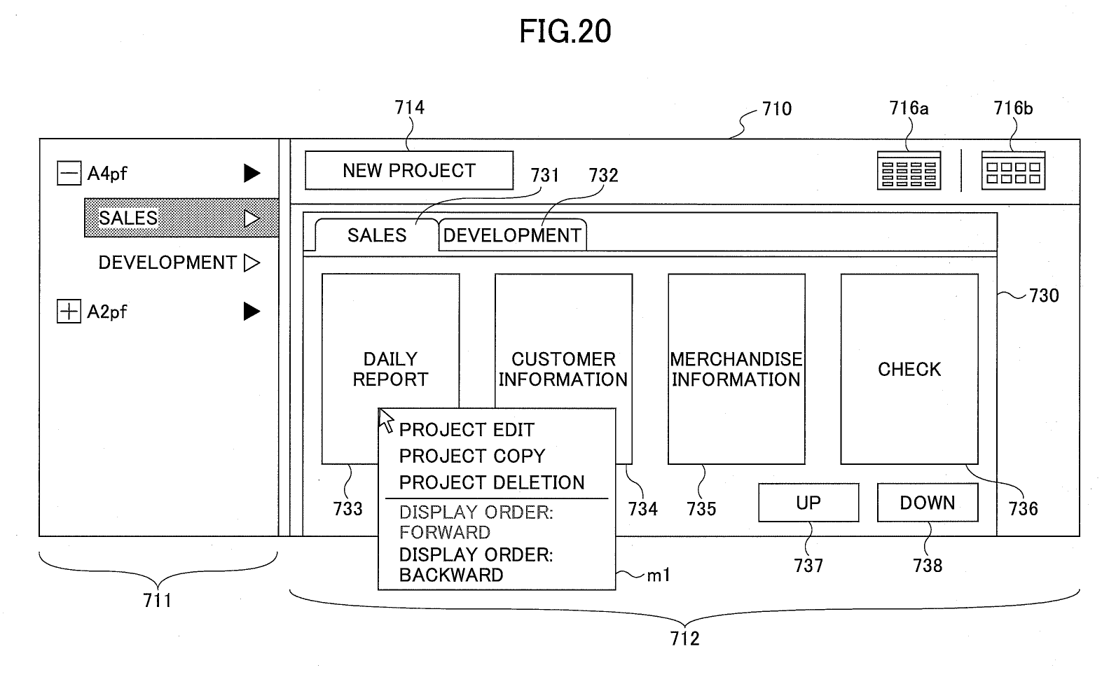

FIG. 20 illustrates an exemplary display of the profile edit screen of the preview format. Referring to FIG. 20, the same reference symbols as those in FIG. 16 are given to the same portions, and explanation of these portions is omitted.

Referring to FIG. 20, the project edit area 712 of the profile edit screen 710 includes a preview screen 730. The preview screen 730 displayed on the operation panel 15 of the apparatus 10, which is associated with the profile to be edited on the profile edit screen 710, shows a display image of the operation screen based on the profile. A display image of the operation screen is the same as an actual display mode or display state, or an approximation of the actual display mode or display state.

Referring to FIG. 20, the preview screen 730 includes a tab 731 corresponding to the “sales” group and a tab 732 corresponding to the “development” group. Further, the tab 731 includes buttons 733 to 736 corresponding to each project belonging to the “sales” group. Further, the preview screen 730 includes an UP button 737 and a DOWN button 738. In a case where the tab 732 is selected on the preview screen 730, a button corresponding to the project belonging to the “development” group 732 is displayed.

Sizes of the display areas (liquid crystal panels) of the operation screens are different depending on the machine kinds (models) of the apparatuses 10. Therefore, provided that the operation screens are displayed on the apparatuses 10 of mutually different machine kinds (models) based on the same profile, there is a possibility that arrangement states of the tabs corresponding to the groups or arrangement states of the buttons corresponding to the projects are different depending on a size difference of the display areas of the operation panels 15. The preview screen 730 enables the user to check the display mode of the operation screen, which is displayed on the operation panel 15 of the apparatus 10 associated with the profile to be edited, depending on the size of the display size.

The user can edit the profile through the preview screen 730. For example, when the new project button 714 is pushed, one button is added to the selected tab. At this time, the process performed in the service providing apparatus 20 is the same as a case where the new project button 714 is pushed under the state where the project view area 713 is displayed in FIG. 16. Said differently, one new profile record is added to the profile memory unit 234.

Further, when the right button in the mouse is clicked on any one of the buttons corresponding to the projects such as the buttons 733 to 736, the administrator terminal 30 displays a context menu ml. The context menu ml includes menu items such as “project edit”, “project copy”, “project deletion”, “display order: forward”, and “display order: backward”. When the menu item of “project edit”, “project copy”, or “project deletion” is selected, the same process as the process performed when the edit button 715a, the copy button 715b, or the deletion button 715c is pushed in FIG. 16 is performed for the project corresponding to the button, on which the right button of the mouse is pushed. When the menu item of “display order: forward” is selected, the display order of the button, on which the right button of the mouse is pushed, moves forward. When the menu item of “display order: backward” is selected, the display order of the button, on which the right button of the mouse is pushed, moves backward.

The UP button 737 and the DOWN button 738 are provided to receive a scroll request of an arrangement area of the buttons corresponding to the projects on the operation screen for a case where the number of the buttons may be so great that the buttons are not simultaneously displayed in a display range. When the DOWN button 738 is pushed, the administrator terminal 30 scrolls the arrangement area of the buttons in a downward direction. When the UP button 737 is pushed, the administrator terminal 30 scrolls the arrangement area of the buttons in an upward direction.

When the view display icon 716a is selected in the state illustrated in FIG. 20, a process similar to that in FIG. 19 is performed. However, in this case, a “view format” is designated as a value of the display format of the switchover destination in the switchover request of the display format sent in step S151. As a result, in step S154, the profile edit screen 710 including the project view area 713 is displayed as illustrated in FIG. 16.

Subsequently, described is the switchover process of the display format of the profile edit screen 710 performed in step S152.

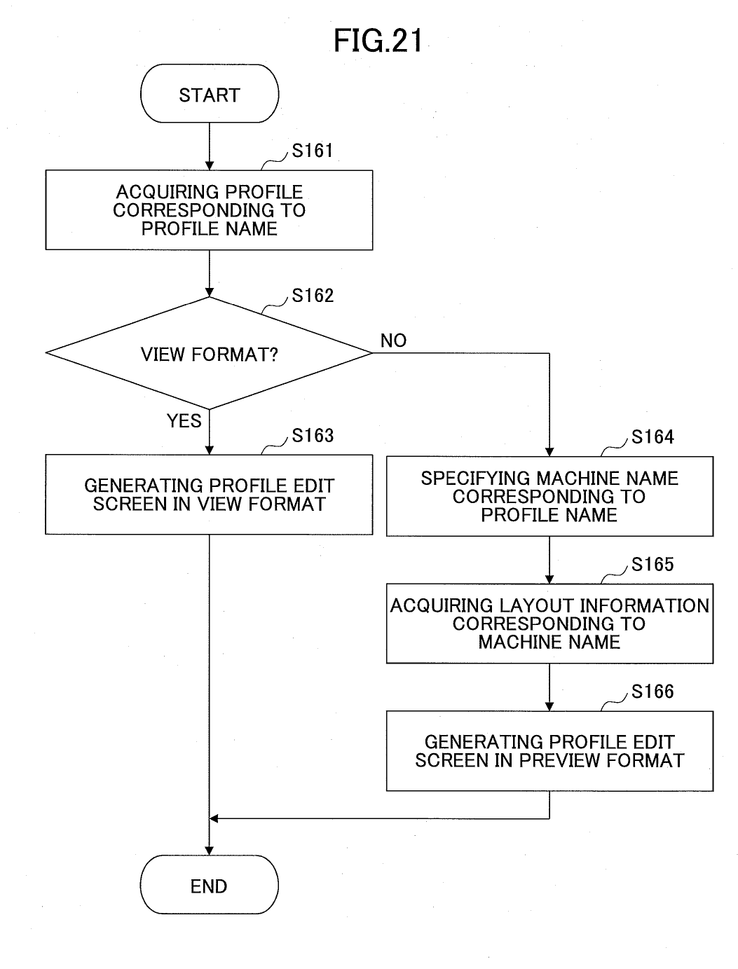

FIG. 21 is a flow chart for explaining an exemplary process of the switchover process of the display format of the profile edit screen.

In a step S161, the screen generation unit 221c acquires the profile corresponding to the profile name designated in the switchover request for switching the display format from the profile memory unit 234. Subsequently, the screen generation unit 221c determines whether the display format of the switchover destination designated to the switchover request is the “view format” or not (step S162). When the display format of the switchover destination is the “view format” (YES in S162), the screen generation unit 221c generates the screen data of the profile edit screen of the view format based on the profile acquired in step S161 (step S163). The profile edit screen 710 of the view format includes the project edit area 712, which includes the project view area 713.

On the other hand, when the display format of the switchover destination designated in the switchover request is the “preview format”, the screen generation unit 221c specifies the machine name corresponding to the profile name designated in the switchover request with reference to the profile apparatus correspondence memory unit 235 and the apparatus information memory unit 232 (step S164). Said differently, by referring to the profile apparatus correspondence memory unit 235, the machine number corresponding to the profile name can be specified. By referring to the apparatus information memory unit 232, the machine name corresponding to the machine number can be specified. As a result, the machine name corresponding to the profile name can be specified.

Subsequently, the screen generation unit 221c acquires layout information corresponding to the specified machine name from the layout information memory unit 236 (step S165).

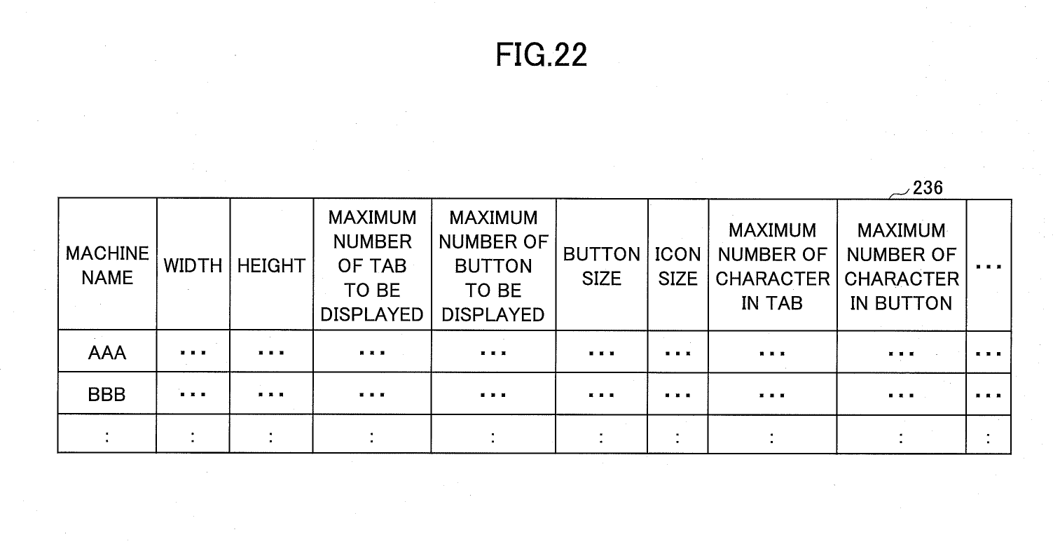

FIG. 22 illustrates an exemplary structure of the layout information memory unit. Referring to FIG. 22, the layout information memory unit 236 stores the layout information of the operation screen in association with the machine name. The layout information includes a width, a height, a maximum number of the tabs to be displayed, a maximum number of buttons to be displayed, a button size, an icon size, a maximum number of characters in the tab, a maximum number of characters in the button, and so on.

The width is the width of the operation screen. The height is the height of the operation screen. The maximum number of the tabs to be displayed is the maximum number of the tabs corresponding to the groups enabled to be simultaneously displayed within the display range of the operation screen. The maximum number of the button to be displayed is the maximum number of the buttons corresponding to the projects enabled to be simultaneously displayed within the display range of the operation screen. The button size is the width and the height of the button corresponding to the project. The icon size is the width and the height of the icon displayed on the button corresponding to the project. The maximum number of the characters in the tab is the maximum value of the characters which can be displayed on the tab corresponding to the group. The maximum number of the characters in the button is the maximum value of the characters which can be displayed on the button corresponding to the project.

Subsequently, the screen generation unit 221c generates the screen data of the profile edit screen 710 of the preview format based on the profile acquired in step S161 and the layout information acquired in step S165 (step S166). The profile edit screen 710 of the preview format includes the project edit area 712, which includes the preview screen 730. The preview screen 730 is generated in conformity with the profile and the layout information. The display order of the buttons corresponding to the project follows the display order of the projects in the profile. In a case where the number of the groups exceeds the maximum number of the tabs to be displayed, the label of the tab on the extreme right indicates that another tab still exists such as “ . . . ”. In a case where the number of the projects exceeds the maximum number of the buttons to be displayed, the preview screen 730 is generates so that the arrangement area of the button scrolls when the DOWN button 738 is pushed. When the group name or the project name exceeds the maximum number of the characters in the tab or the maximum number of the characters in the button, a character string displayed on the tab or the button is shortened or abbreviated so as to have the maximum number of the characters or less. The character string may be shortened or abbreviated by omitting a part exceeding the maximum number of the characters.

Referring to FIG. 21, an example where the layout information is different for each machine name has been described. However, in a case where the layout information is not different for each machine name or the machine names of the apparatuses 10 collaborating with the service providing apparatus 20 are commonly used, one layout information can be used in common with the multiple apparatuses 10.

In this case, step S164 may not be performed as long as the common layout information is acquired.

As described, the switchover of the display format of the profile edit screen 710 is performed based on the profile stored in the profile memory unit 234. Further, the edit result in the project view area 713 and the edit result in the preview screen 730 are sequentially stored (reflected) in profile memory unit 234 so as to update the profiles. Specifically, when it is instructed to add, edit, copy, or delete the project in the project view area 713 or on the preview screen 730, the administrator terminal 30 requests to the setup registration unit 221. The profile update unit 221b of the setup registration unit 221 stores (reflects) the addition, the edit, the copy, or the deletion of the project in the profile memory unit 234 so as to update in response to this request. Every time when “▾” or “▴” is selected in the column of the “order change” in the project view area 713 or every time when “display order: forward” or “display order: backward” is selected in the context menu ml of the preview screen 730, the administrator terminal 30 requests the setup registration unit 221 so that the display order of the target project rises up or falls down. The profile update unit 221b of the setup registration unit 221 causes the display order of the target project to rise up or fall down in the profile memory unit 234 and simultaneously causes the display order of the project replaced by the target project to rise up or fall down in the profile memory unit 234.

Therefore, the display format is switched over in the state where the edit result in one display format effects (is reflected) on the edit result in the other display format. For example, the preview screen 730 corresponding to the edit state in the project view area 713 is displayed. As a result, the user can check the image of the actually displayed operation screen based on the profile while proceeding the edit of the profile.

The switchover process of the display format explained in FIG. 21 may be performed in the administrator terminal 30 instead of the service providing apparatus 20. In this case, the administrator terminal 30 stores the content of the profile edited in response to the operation in the profile edit screen 710 in the memory of the administrator terminal 30 or the like. Hereinafter, the profile stored in this memory or the like is referred to as a “local profile”. The administrator terminal 30 effects (reflects) the edit result in the project view area 713 or the preview screen 730 also on the local profile. In a case where the switchover of the display format is instructed, the administrator terminal 30 uses the local profile to perform the process illustrated in FIG. 21. At this time, the layout information corresponding to the local profile may be downloaded from the service providing apparatus 20. This process performed by the administrator terminal 30 is performed based on the script (the command group) defined for, for example, the profile edit screen 710.

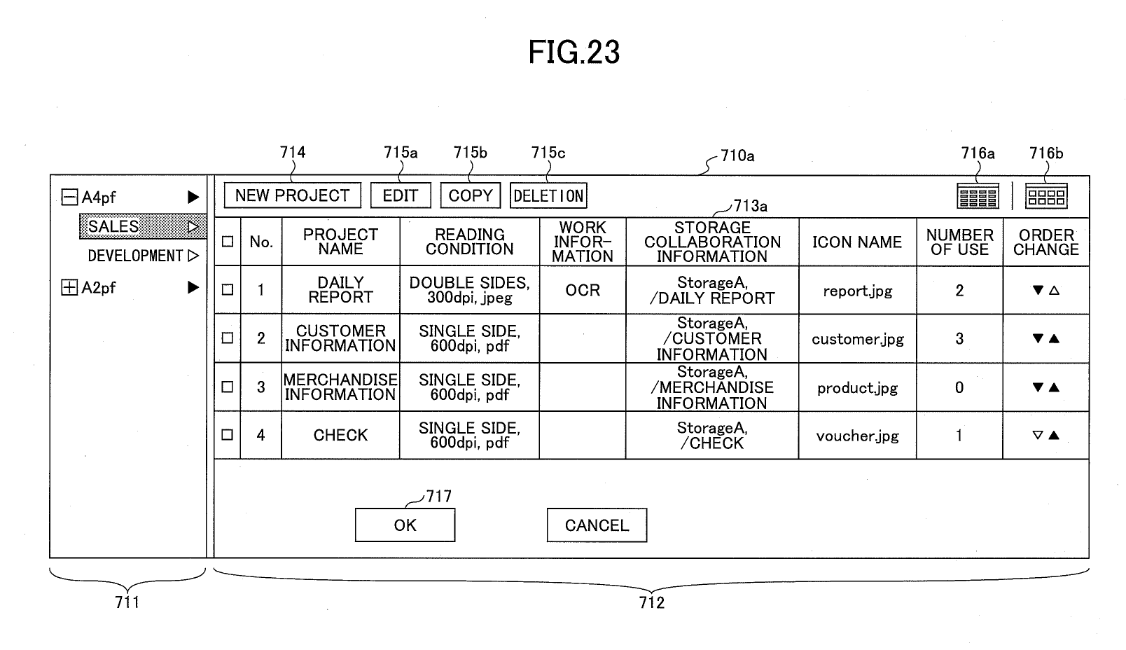

The profile edit screen 710 may be used at a time of editing the existing profile, which is already started to be used. At this time, if it is possible to refer a usage situation about the display order of the button corresponding to the project in using the buttons by the users, an operability of the operation screen displayed based on the profile can be improved. Therefore, the screen generation unit 221c of the setup registration unit 221 may generate the screen data causing the profile edit screen 710a illustrated in FIG. 23 to be displayed.

FIG. 23 illustrates an exemplary display of the profile edit screen. Referring to FIG. 23, the same reference symbols as those in FIG. 16 are given to the same portions, and explanation of these portions is omitted.

In a profile edit screen 710a illustrated in FIG. 23, a project view area 713a includes the number of uses for each project. The number of the uses indicates the number of times when the project is used. For example, the user can place the project having a greater number of the uses at upper position in the display order. With this, the operability of the operation screen based on the profile to be edited can be improved.

The number of the uses of each project can be specified based on, for example, history information stored in a usage history memory unit 237.

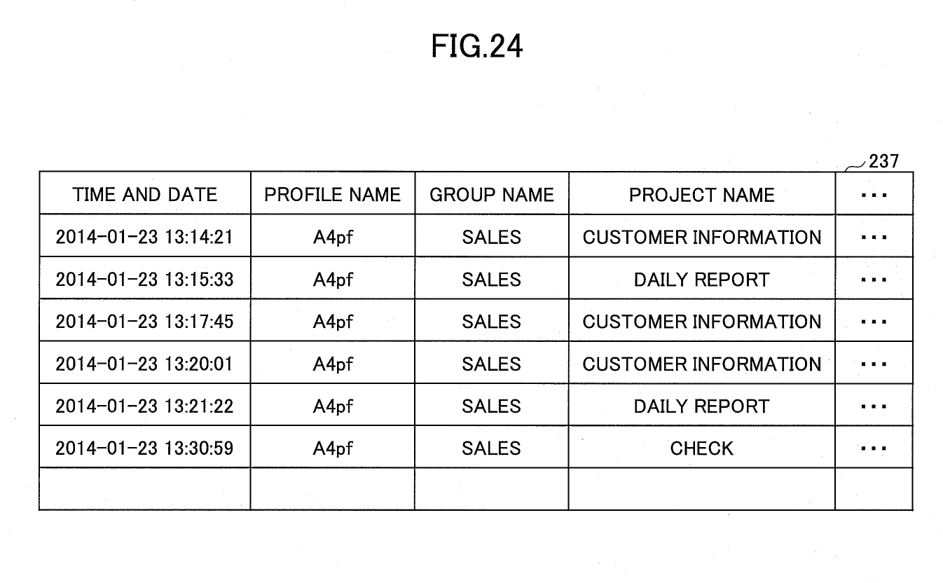

FIG. 24 illustrates a structural example of the usage history memory unit. Referring to FIG. 24, the usage history memory unit 237 stores a time and date, the profile name, the group name, the project name, and so on for each use of the project. The time and date is when the project is used. The profile name, the group name, and the project name relate to the used project.

At the time of generating the screen data of the profile edit screen 710a, the screen generation unit 221c counts the number of records whose profile name, group name, and project name match those of each of the project belonging to the profile and the group, which are to be edited, among the records stored in the usage history memory unit 237. The setup registration unit 221 sets a resultant value of the count to the number of uses in the project view area 713a.

If the number of the uses is counted for each project belonging to the group at every switchover of the groups to be edited by the selection of the node in the tree area 711 of the profile edit screen 710a, a response in switching over the groups to be edited may be degraded. Therefore, the numbers of the uses for each project may be recorded in, for example, the profile memory unit 234.

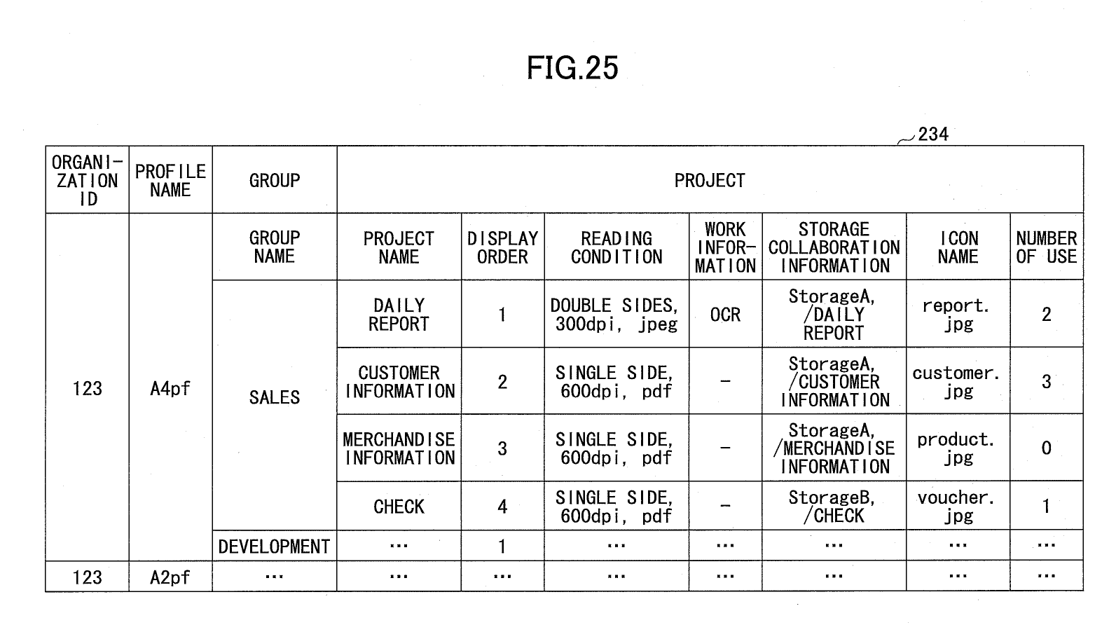

FIG. 25 illustrates a second structural example of the profile memory unit. Referring to FIG. 25, the project record of the profile memory unit 234 further includes an item of the number of the uses. One (1) is added to the value of the item of the number of the uses at every use of the project. According to this profile memory unit 234, it is possible to lower a necessity of counting the number of the uses of each project based on the history information.

The screen generation unit 221c may automatically determine the display order of the projects based on the number of the uses at a time of generating the project view area 713 or the preview screen 730 of the existing profile. For example, the project whose number of the uses is greater may be displayed at an upper position in the display order. With this, it is possible to provide the profile edit screen 710 including the project view area 713 or the preview screen 730, in which the display order of the projects is already sorted using the number of the uses. In a case where the display order is automatically determined, the screen generation unit 221c may update the value of the display order of each project record in the profile memory unit 234 to be an automatically determined display order.

Further, information indicative of the usage situation of the project by the user may not be the number of the uses. For example, the time and date when the project is finally used may be used instead of the number of the uses.

Subsequently, described is a procedure performed in the information processing system 1 when the ScanToStorage service is used by a member user.

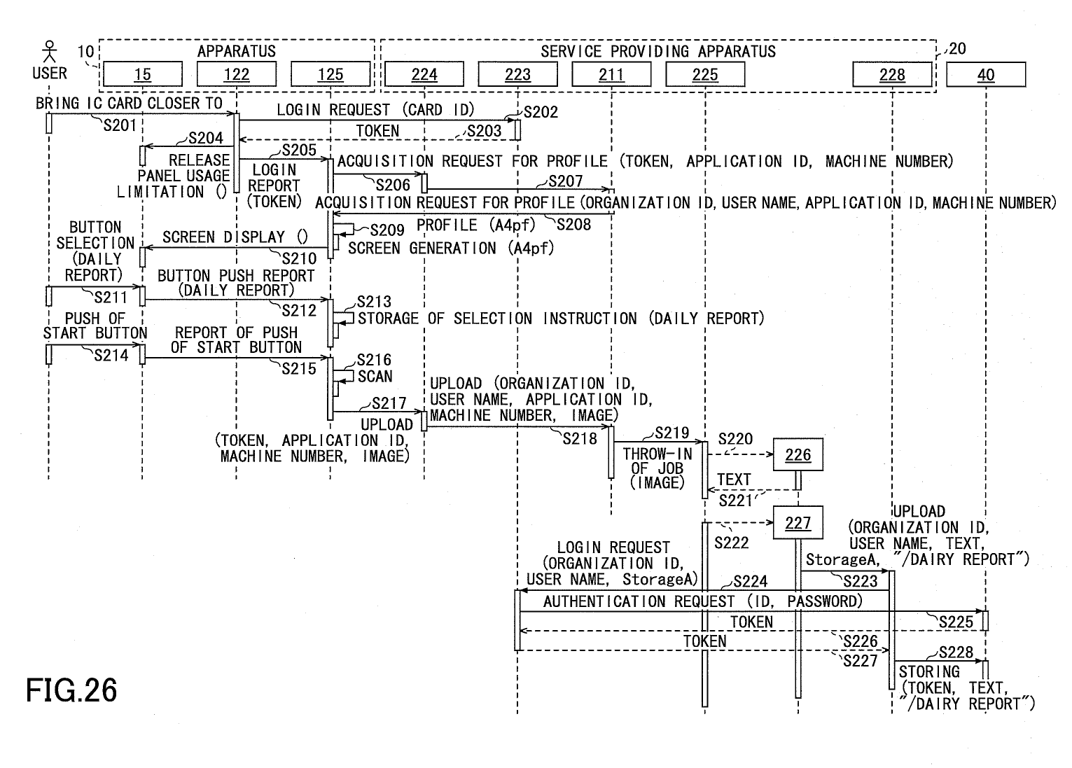

FIG. 26 is a sequence chart for explaining an exemplary procedure at a time of using the ScanToStorage service. Referring to FIG. 26, the apparatus 10 to be operated is simply referred to as the “apparatus 10”, and the member user who operates the apparatus 10 is simply referred to as a “user”. At a time of starting the procedure illustrated in FIG. 26, no user is logging in the apparatus 10.

When the user brings an IC card closer to a card reader (not illustrated) in order to log in the apparatus 10, the apparatus authentication unit 122 acquires a card ID from the IC card through the card reader (step S201). Subsequently, the apparatus authentication unit 122 sends an authentication request including the card ID to the service providing apparatus 20 (step S202).

The authentication processing unit 223 of the service providing apparatus 20 authenticates using the card ID included in the authentication request in response to a receipt of the authentication request. For example, if the record including the card ID is stored in the user information memory unit 231, the authentication may be determined to be successfully completed. The organization ID and the machine number may be sent along with the card ID from the apparatus 10. In this case, if there is no contradiction in a combination of the organization ID, the machine number, and the card number, the authentication may be determined to be successfully completed. In a case where the authentication is successfully completed, the session administration unit 224 opens a session with the apparatus 10. The session administration unit 224 stores the organization ID and the user name, which are associated with the card ID in the user information memory unit 231, into the memory device 203 while associating the organization ID and the user name with the session. The session administration unit 224 generates a token (cookie) which is identification information of the session. The authentication processing unit 223 returns a response, which indicates a success of the authentication and is caused, by the authentication processing unit 223, to include the token, to the apparatus authentication unit 122 of the apparatus 10 (step S203).

The apparatus authentication unit 122 stores the token included in the response upon receipt of the response including the success of the authentication in the RAM 112. The apparatus authentication unit 122 releases a limitation (a lock) to a usage of the operation panel 15 in order to enable a user operation (step S204). By releasing the limitation to the usage, the user can operate the apparatus 1 through the operation panel 15.

Subsequently, the apparatus authentication unit 122 reports the success of the login to each application started up inside the apparatus 10. Within the embodiment, the success of the login is reported to the scan apparatus application 125 (step S205). The token is attached to the report of the success of the login. Therefore, the scanning apparatus application 125 obtains the token through the report.

Subsequently, if the scan apparatus application 125 is selected as an object to be used by an operation through the operation panel 15 by the user, the scan apparatus application 125 sends an acquisition request to acquire a profile to the scan server application 211 of the service providing apparatus 20 while designating the own application ID, the token, the machine number of the apparatus 10 (the own machine), and so on (step S206). The session administration unit 224 of the service providing apparatus 20 relays the acquisition request. When the relay is performed, the session administration unit 224 converts the token included in the acquisition request to the organization ID and the user name, which are identified by the token, and transfers the acquisition request to the scan server application 211 (step S207). The session administration unit 224 rejects the acquisition request including an incorrect token.

Subsequently, the scan server application 211 specifies the application ID designated in the acquisition require and the profile name associated with the machine number by referring to the profile apparatus correspondence memory unit 235 (FIG. 15). Further, the scan server application 211 acquires the specified profile name and the profile identified by the organization ID converted from the token from the profile memory unit 234 (FIG. 17), and returns the acquired profile to the scanning apparatus application 123 (step S208).

The scanning apparatus application 125 generates the operation screen based on the returned profile (step S209). At this time, the operation screen is generated so as to correspond to the operation panel 15 of the apparatus 10. For example, the layout information corresponding to the machine name of the apparatus 10 is acquired from the layout information memory unit 236 and the operation screen may be generated based on the layout information.

Subsequently, the scanning apparatus application 125 displays the operation screen on the operation panel 15 (step S210). Specifically, the display control unit 124 generates the operation screen based on the profile and displays the operation screen on the operation panel 15.

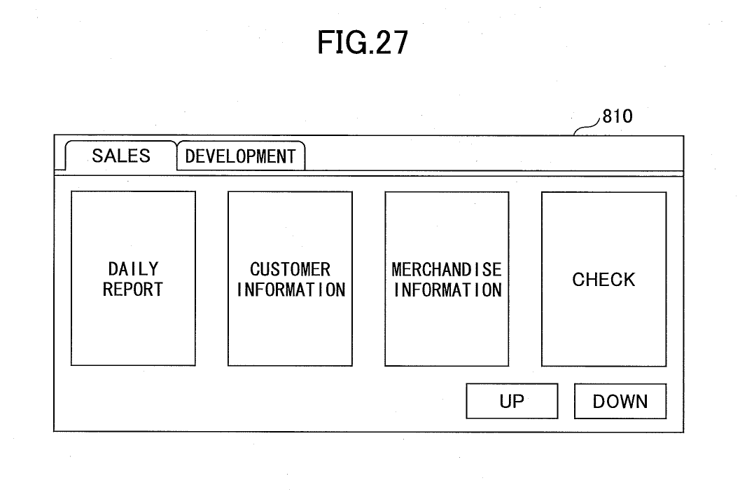

FIG. 27 illustrates an exemplary display of the operation screen of the scan apparatus application. An operation screen 810 illustrated in FIG. 27 is the same as the screen illustrated in the preview screen 730 illustrated in FIG. 20.

Subsequently, a button suitable for a user business is selected from buttons of the operation screen 810 by the user (step S211). For example, in a case where the dairy report is an object of the scan, a button 811 is selected. When the button selection is reported by the operation panel 15 (step S212), the scan apparatus application 125 stores the group name and the project name, which correspond to the selected button 811 (“dairy report”), and a reading condition into the RAM 112 (step S213). This reading, condition is included in the profile used to generate the operation screen 810.

Subsequently, an original manuscript (e.g., the daily report) to be scanned is set by the user to the apparatus 10 and a start button on the operation panel 15 is pushed (step S214), the operation panel 15 reports the push of the start button to the scan apparatus application 125 (step S215). In response to the push of the start button, the scan apparatus application 125 causes the apparatus 10 to perform the scan job for the original manuscript through the apparatus control unit 121 (step S216). Said differently, image data are read from the original manuscript by the scanner 12. At this time, the used reading condition had been stored in the RAM 112 in step S213. Therefore, the original manuscript is scanned using the reading condition suitable for scanning of the daily report, and the image data are generated.

Subsequently, the scan apparatus application 125 sends (uploads) the image data to the scan server application 211 along with the own application ID, the machine number, the group name and the project name of the selected button, and the token (step S217). The session administration unit 224 converts the token to the organization ID and the user name, and transfers a result of the conversion, the application ID, the machine number, the group name, the project name, and the image data to the scan server application 211 (step S218).

The scan server application 211 specifies the profile corresponding to the transferred application ID and machine number based on the profile apparatus correspondence memory unit and the profile memory unit 234 and specifies the work information and the storage collaboration information corresponding to the transferred group name and project name in the profile. Further, the scan server application 211 stores the profile name of the profile, the group name, and the history information related to the project name in the usage history memory unit 237. The scan server application 211 adds one (1) to the number of the uses for the profile name, the group name, and the project name in the profile memory unit 234 illustrated in FIG. 25.

The scan server application 211 inputs an execution request of a job (hereinafter, referred to as “job A”) indicating a process corresponding to the work information and the storage collaboration information to the job processing unit 225 (step S219). Here, the work information indicates an OCR process, and the storage information indicates a storage (an upload) of StorageA to a folder of “/daily report”. Further, the organization ID corresponding to the apparatus 10, the user name, and the scanned image data are associated with the job. The execution request for executing the job is accumulated in a job queue formed in the RAM 112. The job is performed out of synchronization with the execution request of the job. However, the job may be performed in synchronization with the execution request for executing the job.

Subsequently, after the job processing unit 225 takes out job A from the job queue, the job processing unit 225 requests an OCR process to the OCR processing unit 226 based on the work information corresponding the job A (step S220). The OCR processing unit 226 performs the OCR process to the image data and outputs text data as a processing result (step S221).

Subsequently, the job processing unit 225 requests an upload processing unit 227 to perform an upload along with a designation of the text data, the storage name and the folder name indicated by the storage collaboration information, the organization ID, and the user name (step S222). The upload processing unit 227 requests the storage collaboration unit 228 to perform a process corresponding to the upload (step S223).

The storage collaboration unit 228 requests a login to the online storage system 40 corresponding to the designated storage name to the authentication processing unit 223 (step S224). The storage collaboration unit 228 designates the organization ID designated by the upload request and the storage name into the login request. The authentication processing unit 223 acquires the organization record corresponding to the organization ID from the user information memory unit 231, and acquires account information (the ID and the password) associated with the storage name corresponding to the upload request from the storage account information of the organization record. The authentication processing unit 223 sends an authentication request to, for example, the online storage system 40 (hereinafter, referred to as “StorageA”) corresponding to StorageA using the acquired account information (step S225).

When the authentication of the account information designated in the authentication request is successfully completed, the StorageA returns a token for accessing Storage A (step S226). The authentication processing unit 223 returns the returned token to the storage collaboration unit 228 (step S227).

Therefore, the storage collaboration unit 228 designates the token and sends a storage request for storing the text data obtained by the OCR process to the online storage (Storage A) specified by the storage name designated by the upload request (step S228). At this time, the folder name (“/daily report”) designated in the upload request is designated as the folder of the storage destination.

As a result, the text data are stored in “/daily report” of Storage A.

As described, within the embodiment, the preview screen 730 concerning the profile of the operation screen displayed on the apparatus 10 for the ScanToStorage service can be displayed on the administrator terminal 30. Therefore, the user can easily check the image of the operation screen to be displayed on the apparatus 10 based on the profile.

The profile edit screen 710 of the view format and the profile edit screen 710 of the preview format can be easily switched over, and the edit result in one of the profile edit screen 710 of the view format and the profile edit screen 710 of the preview format can be copied to (reflected on) the other. Therefore, the user can check a display image of the operation screen according to the edit result up to the present time point in response to a progress of the edit of the profile.

Within the embodiment, described is the ScanToStorage service where an input source of the image data is the scanner and an output destination is the storage. The input source and output destination of the image data may be other than the scanner or the storage. The input source of the image data is, for example, a digital camera (including a portable terminal having a digital camera function), a whiteboard, or the like. In the case of the digital camera, the image data captured by the digital camera is an input object. In the case of the whiteboard, the image data written on and read by the whiteboard is the input object. The output destination of the image data is, for example, an image projecting apparatus such as a projector, a printer, a conference system, a mobile terminal, or the like. Said differently, the embodiment can be applied to the operation screen displayed on the apparatus other than the image forming apparatus.

Within the embodiment, the service providing apparatus 20 is an example of an information processing system. The administrator terminal 30 is an example of the client apparatus. The profile is an example of the definition information. The tab, the button and so on are an example of the composition element of the operation screen. The request receiving unit 221a is an example of a receiving unit. The screen generation unit 221c is an example of a generation unit. The response return unit 221d is an example of a sending unit. The profile update unit 221b is an example of an updating unit. The profile edit screen 710 of the preview format is an example of a first screen. The profile edit screen 710 of the view format is an example of a second screen. The operations panel 15 is an example of a display unit of the apparatus. The layout information is an example of arrangement information. The screen data are an example of display data.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the information processing system has been described in detail, it should be understood that various changes, substitutions, and alterations could be made thereto without departing from the spirit and scope of the invention.

This application is based upon and claims the benefit of priority of the prior Japanese Patent Application No. 2014-047898, filed on Mar. 11, 2014, the entire contents of which are incorporated herein by reference.

What is claimed is:

1. An information processing system including at least one information processing apparatus, the information processing system comprising:
a receiving unit that receives definition information for defining composition elements of an operation screen displayed on an apparatus connected to the information processing system through a network in order to cause the apparatus and a computer system connected to the information processing system through the network to collaborate through the information processing system from a client apparatus used to edit the definition information;
a generation unit that generates display data for displaying a first screen including the operation screen in a mode corresponding to a display unit based on the definition information received by the receiving unit; and
a sending unit that sends the display data generated by the generation unit to the client apparatus.

2. The information processing system according to claim 1, the information processing system further comprising:
a first memory unit that stores arrangement information of the composition elements defined in the definition information for each machine kind of the apparatus,
wherein the definition information is generated for a specific apparatus,
wherein the generation unit generates the display data for displaying the first screen including the operation screen in the mode corresponding to the display unit of the machine kind of the specific apparatus based on the arrangement information stored in the first memory unit and the definition information.

3. The information processing system according to claim 1,
wherein the generation unit generates display data of a second screen, which includes a view of definitions for each of the composition elements defined in the definition information at a portion corresponding to the operation screen of the first screen and is provided to be displayed in response to a first request sent from the client apparatus upon an operation on the first screen displayed in the client apparatus,
wherein the sending unit sends the display data for displaying the second screen to the client apparatus.

4. The information processing system according to claim 3, the information processing system further comprising:
an updating unit that updates the definition information in response to a second request sent from the client apparatus depending on the edit of the definitions on the second screen displayed on the client apparatus.

5. The information processing system according to claim 3,
wherein the generation unit generates the display data for the first screen in response to a third request sent from the client apparatus upon an operation on the second screen displayed on the client apparatus,
wherein the sending unit sends the display data for displaying the first screen to the client apparatus.

6. The information processing system according to claim 3, the information processing system further comprising:
a second memory unit that stores information indicative of a usage situation of each of the composition elements of the operation screen,
wherein the generation unit generates the display data for the second screen including information indicative of the usage situation stored in the second memory unit.

7. The information processing system according to claim 3, the information processing system further comprising:
a second memory unit that stores information indicative of a usage situation of each of the composition elements of the operation screen,
wherein the generation unit determines an order of arranging the information for each of the composition element based on the information indicative of the usage situation stored in the second memory unit.

8. A method of processing information in an information processing system including at least one information processing apparatus, the method comprising:
receiving definition information for defining composition elements of an operation screen displayed on an apparatus connected to the information processing system through a network in order to cause the apparatus and a computer system connected to the information processing system through the network to collaborate through the information processing system from a client apparatus used to edit the definition information;
generating display data for displaying a first screen including the operation screen in a mode corresponding to a display unit based on the definition information received by the receiving; and
sending the display data generated by the generating to the client apparatus.

9. A client apparatus connected to an information processing system through a network, the client apparatus comprising:
a client apparatus display unit for displaying a first screen and a second screen,
wherein the first screen including an operation screen to be displayed on an apparatus in a mode corresponding to an apparatus display unit of the apparatus in order to cause the apparatus and a computer system connected to the information processing system through the network to collaborate through the information processing system, the first screen being displayed based on a display data in response to a receipt of the display data from the information processing system,
wherein the second screen including a view of definitions of each of composition elements of the operation screen of the first screen to be displayed on the apparatus in conformity with a command group concerning the display data received in response to an operation to the first screen, the second screen being provided to edit the definitions of each of composition elements.

10. The client apparatus according to claim 9,
wherein the client apparatus display unit displays the display data of the first screen including the operation screen based on the view of the definitions for each of the composition elements in conformity with the command group in response to an operation to the second screen.
